(19) United States
(12) Patent Application Publication
(10) Pub. No.: US 2023/0101880 A1
(43) Pub. Date: Mar. 30, 2023

(54) ALUMINUM TITANATE-CONTAINING PARTICLES, AT-CONTAINING GREEN AND CERAMIC HONEYCOMB BODIES, BATCH MIXTURES, AND METHODS OF MANUFACTURE

(71) Applicant: CORNING INCORPORATED, CORNING, NY (US)

(72) Inventors: Patrick David Tepesch, CORNING, NY (US); Elizabeth Marie Vileno, CORNING, NY (US)

(21) Appl. No.: 17/910,099

(22) PCT Filed: Mar. 19, 2021
(86) PCT No.: PCT/US2021/023190

§ 371 Date: Sep. 8, 2022

Related U.S. Application Data
(60) Provisional application No. 62/992,226, filed on Mar. 20, 2020.

(51) Int. Cl. C04B 35/478; C04B 35/626; C04B 38/00

(52) U.S. Cl. CPC C04B 35/478; C04B 35/6262; C04B 38/0006; C04B 2235/349; C04B 2235/5436; C04B 2235/5463; C04B 2235/6567; C04B 2235/85

(57) ABSTRACT

Aluminum titanate-containing particles made up of a conglomerate of multiple partial grains. The aluminum titanate-containing particles are formed by breaking apart ceramic bodies along cracks, which are formed predominantly through the grains, rather than between the grains. Batch mixtures forming the aluminum titanate-containing particles, as well as batch mixtures utilizing the aluminum titanate particles are disclosed. Green bodies, such as green honeycomb bodies having peak intensity ratios (PIRs) in an axial direction of less than or equal to 0.50, ceramic honeycomb bodies, methods of manufacturing green honeycomb bodies, and ceramic honeycomb bodies are provided, as are other aspects.

### CROSS REFERENCE TO RELATED APPLICATION

This application claims the benefit of priority under 35 U.S.C. § 119 of U.S. Provisional Application Ser. No. 62/992,226 filed on Mar. 20, 2020, the content of which is relied upon and incorporated herein by reference in its entirety.

### BACKGROUND

The present disclosure relates to aluminum-titanate (AT) containing particles, green and ceramic honeycomb bodies manufactured therefrom, batch mixtures configured to form such AT particles and honeycomb bodies, and methods of manufacturing such AT particles and honeycomb bodies.

Formed ceramic bodies, for example porous ceramic honeycomb bodies, may be used in a variety of applications. Such formed ceramic honeycomb bodies may be used, for example, as supports for catalysts for carrying out catalyzed reactions, as sorbents, or as filters for the capture of particulates from fluids such as gas or liquid streams, such as vehicle engine exhaust.

### SUMMARY

In accordance with various embodiments of the disclosure aluminum titanate-containing particles and methods of manufacturing aluminum titanate-containing particles are disclosed.

In some embodiments, a method of manufacturing aluminum titanate-containing particles comprises: forming a batch mixture of inorganic materials from: an alumina source, a titania source, a sintering aid comprising at least one of clay, talc, or cordierite, wherein the sintering aid is provided in the batch in an amount of less than or equal to 5 wt % based upon the total weight of inorganics in the batch mixture; forming a green body from the batch mixture; firing the green body to form a ceramic body comprising grains of aluminum titanate, forming intragranular microcracks in the grains of aluminum titanate; and breaking the ceramic body along the microcracks to form the aluminum titanate-containing particles.

In some embodiments, forming the intragranular microcracks comprises cooling the ceramic body.

In some embodiments, the aluminum titanate-containing particles comprise a conglomerate of multiple partial grains of aluminum titanate bonded together by one or more silica-containing bonding layers at grain boundaries between the partial grains, wherein the multiple partial grains in each aluminum titanate-containing particle have multiple different grain orientations.

In some embodiments, after firing the ceramic body has less than 1 wt % of a crystalline cordierite phase.

In some embodiments, after firing the ceramic has less than 0.1 wt % of a crystalline cordierite phase.

In some embodiments, after firing, the ceramic body comprises no crystalline cordierite phase.

In some embodiments, the aluminum titanate-containing particles comprise a median particle diameter of from 18 μm to 70 μm.

In some embodiments, the aluminum titanate-containing particles having a particle distribution having df≤1.0.

In some embodiments, the method further comprises removing one or more particle fractions from the aluminum titanate-containing particles to form sieved aluminum titanate-containing particles comprising a median particle diameter of from 25 μm to 55 μm.

In some embodiments, the batch mixture further comprises a magnesia source.

In some embodiments, the magnesia source comprises MgO, Mg(OH)2, or magnesium aluminate (spinel).

In some embodiments, the aluminum titanate-containing particles comprise d10≥5 μm.

In some embodiments, the aluminum titanate-containing particles comprise d10≥10 μm.

In some embodiments, the source of titania comprises rutile phase titania or anatase phase titania.

In some embodiments, the source of alumina comprises hydrated alumina, calcined alumina, or magnesium aluminate (spinel).

In some embodiments, the sintering aid is provided in the batch mixture in an amount of less than or equal to 3.0 wt % based upon the total weight of inorganics in the batch mixture.

In some embodiments, the sintering aid is provided in an amount of less than or equal to 2.0 wt % based upon the total weight of inorganics in the batch mixture.

In some embodiments, the sintering aid is provided in an amount of less than or equal to 1.0 wt % based upon the total weight of inorganics in the batch mixture.

In some embodiments, the batch mixture contains less than or equal to 1.8 wt % of silica based upon the total weight of inorganics in the batch mixture.

In some embodiments, the sintering aid comprises clay having a median particle diameter of less than 40 μm.

In some embodiments, the sintering aid comprises talc having a median particle diameter from 5 μm to 40 μm.

In some embodiments, the batch mixture comprises talc in an amount of less than or equal to 2.8 wt % based upon the total weight of inorganics in the batch mixture.

In some embodiments, the sintering aid comprises cordierite having a median particle diameter of less than 50 μm.

In some embodiments, the sintering aid comprises cordierite having a median particle diameter from 1 μm to 25 μm.

In some embodiments, the batch mixture comprises cordierite in an amount of less than or equal to 3.5 wt % based upon the total weight of inorganics in the batch mixture.

In some embodiments, the firing the green body comprises a top soak temperature of from 1350° C. to 1700° C.

In some embodiments, the top soak temperature is from 1475° C. to 1625° C.

In some embodiments, the firing the green body is carried out at the top soak temperature for a firing time of from 1 hour to 10 hours.

In some embodiments, the firing time is from 2 hours to 6 hours.

In some embodiments, the forming a green body from the batch mixture comprises extruding strands or granularizing.

In some embodiments, the breaking the ceramic body to form the aluminum titanate-containing particles comprises milling the ceramic body.

In some embodiments, the aluminum titanate-containing particles comprise partial grains, each partial grain further having faces created by by intragrain fractures.

In some embodiments, the aluminum titanate-containing particles comprise a conglomerate of multiple partial grains.

In some embodiments, the aluminum titanate-containing particles comprising the conglomerate of multiple partial grains comprise substantially no microcracking therein.

In some embodiments, the ceramic body comprises substantially no intergranular microcracks before breaking.

In some embodiments, an aluminum titanate-containing particle comprises a conglomerate of multiple partial grains of aluminum titanate bonded together by one or more silica-containing bonding layers at grain boundaries between the partial grains, wherein the multiple partial grains have multiple different grain orientations.

In some embodiments, the particle further comprises substantially no internal microcracking.

In some embodiments, the particle further comprises substantially-pure solid solution of aluminum titanate and magnesium dititanate.

In some embodiments, the particle further comprises less than 25 wt % of the magnesium dititanate.

In some embodiments, the particle further comprises greater than or equal to 98 wt % of a solid solution of aluminum titanate and magnesium dititanate.

In some embodiments, the one or more bonding layers comprise silica.

In some embodiments, a method of manufacturing a green honeycomb body comprises forming a honeycomb-forming batch mixture containing: aluminum titanate-containing particles comprising a conglomerate of multiple partial grains, an alumina source, and a silica source; and forming the green honeycomb body from the batch mixture, wherein the green honeycomb body comprises a peak intensity ratio in an axial direction of less than 0.50, when dried.

In some embodiments, before forming the honeycomb-forming batch mixture the method further comprises: forming intragrain microcracks in grains of an aluminum titanate material due to thermal expansion anisotropy of aluminum titanate material; and breaking the aluminium titanate material along the intragrain microcracks to form the aluminum titanate-containing particles.

In some embodiments, the method further comprises a magnesia source.

In some embodiments, a green honeycomb body comprises aluminum titanate-containing particles comprising a conglomerate of multiple partial grains; an alumina source; a silica source; and wherein the green honeycomb body comprises a peak intensity ratio in an axial direction of less than 0.50, when dried.

In some embodiments, the green body further comprises a magnesia source.

In some embodiments, the multiple partial grains comprise intragranularly fractured surfaces.

In some embodiments, the multiple partial grains are bonded by one or more silica-containing bonding layers to form the conglomerate.

In some embodiments, a ceramic honeycomb body comprises: an aluminum titanate-containing phase comprising axial CTE and tangential CTE falling on or below the line y=1.3x+9.0×10−7 wherein y is tangential CTE and x is axial CTE each measured from RT to 800° C. and in units of 10−7/° C. wherein the aluminum titanate-containing phase comprises particles made up of a conglomerate of multiple partial grains.

In some embodiments, the axial CTE and the tangential CTE fall on or below the line y=1.3x+7.5×10−7/° C.

In some embodiments, the axial CTE and the tangential CTE fall on or below the line y=1.3x+6.0×10−7/° C.

In some embodiments, the multiple partial grains comprise intragranularly fractured surfaces.

In some embodiments, the multiple partial grains are bonded by one or more silica-containing bonding layers to form the conglomerate.

In some embodiments, a method of manufacturing aluminum titanate-containing particles comprises forming a batch mixture of inorganic materials from: an alumina source, a titania source, a magnesia source, and a sintering aid comprising clay, talc, or cordierite, wherein the sintering aid is provided in the batch in an amount of at least 0.25 wt % based upon the total weight of inorganics in the batch; forming a green body from the batch mixture; firing the green body to form a ceramic body comprising aluminum titanate and having at most 1 wt % of a crystalline cordierite phase; and breaking the ceramic body to form the aluminum titanate-containing particles.

In some embodiments, the aluminum titanate-containing particles comprise a conglomerate of multiple partial grains of aluminum titanate bonded together by one or more silica-containing bonding layers at grain boundaries between the partial grains.

In some embodiments, after firing the ceramic body comprises less than 0.1 wt % of a crystalline cordierite phase.

In some embodiments, after firing the green body, the method further comprises forming intragrain microcracks in grains of the aluminum titanate due to thermal expansion anisotropy in the grains of the aluminum titanate; and wherein breaking the ceramic body comprises breaking the aluminum titanate grains along the intragrain microcracks to form the aluminum titanate-containing particles.

Additional features of the present disclosure will be set forth in the description which follows, and in part will be apparent from the description, or may be learned by practice of the embodiments disclosed herein. Both the foregoing general description and the following detailed description provide numerous examples and are intended to provide further explanation of the disclosure.

### BRIEF DESCRIPTION OF THE DRAWINGS

FIGS. 1 and 2 schematically illustrate perspective views of honeycomb bodies (FIG. 1—unplugged; FIG. 2—plugged) according to embodiments disclosed herein.

FIG. 3A illustrates a scanning electron micrograph (SEM) of representative aluminum titanate-containing particles comprising a conglomerate of multiple partial AT grains according to embodiments disclosed herein.

FIG. 3B illustrates a side view schematic depiction of an aluminum titanate-containing particle comprising a conglomerate of multiple partial AT grains according to embodiments disclosed herein.

FIG. 3C is an electron backscatter diffraction (EBSD) image of a plurality of aluminum titanate-containing particles comprising conglomerates of multiple partial AT grains according to embodiments disclosed herein, where the different colors represent AT grains that are oriented at least 5° from each other.

FIG. 4A illustrates a cross-sectioned side view of a receptacle containing a green body of batch material in the form of spaghetti strands according to embodiments disclosed herein.

FIG. 4B illustrates a side view of ceramic body comprising a collection of fired spaghetti strands according to embodiments disclosed herein.

FIG. 4C illustrates a magnified SEM of a portion of a ceramic body showing the presence of intragranular microcracks according to embodiments disclosed herein.

FIG. 4D illustrates a magnified SEM of a portion of a ceramic body showing the presence of intergranular microcracks, in contrast to the intragranular microcracks of FIG. 4C.

FIG. 5 illustrates a partially cross-sectioned side view of an extruder apparatus useful in the manufacture of green honeycomb bodies from batch mixtures containing aluminum titanate-containing particles according to embodiments disclosed herein.

FIG. 6 illustrates a flowchart of a method of manufacturing aluminum titanate-containing particles comprising conglomerates of multiple partial grains and of manufacturing honeycomb bodies comprising the aluminum titanate-containing particles, according to embodiments disclosed herein.

FIG. 7 is a graph showing the Peak Intensity Ratio (PIR) for green honeycomb bodies (green ware) that comprise various sintering aids or no sintering aid according to various embodiments disclosed herein.

FIG. 8 is a graph showing tangential CTE versus axial CTE of ceramic honeycomb bodies comprising various aluminum titanate-containing particles according to various embodiments disclosed herein.

FIG. 9 is a graph showing the difference between tangential CTE and axial CTE of ceramic honeycomb bodies comprising various aluminum titanate-containing particles according to various embodiments disclosed herein.

### DETAILED DESCRIPTION

Embodiments of the disclosure relate to methods of manufacture of aluminum titanate-containing particles, batch mixtures used to form the aluminum titanate-containing particles, and aluminum titanate-containing particles, as well as batch mixtures comprising the aluminum titanate particles, green honeycomb bodies manufactured using the aluminum titanate-containing particles, and ceramic honeycomb bodies manufactured using the aluminum titanate-containing particles.

In honeycomb bodies in which AT is a dominant phase (i.e., greater than 50 wt %), the orientation of the AT grains has a significant impact on the CTE of the honeycomb body along a particular direction (with such impact being greater for larger wt % of AT in the honeycomb body). This can cause high stress in the tangential direction, leading to early failure of the honeycomb body. For example, such alignment of the orientation of AT grains can result during a honeycomb extrusion process as the AT or AT-forming particles in a ceramic-forming batch mixture are forced through narrow slots in the extrusion die. Advantageously, AT-containing particles according to embodiments disclosed herein can be utilized in the manufacture of AT honeycomb bodies to improve (lower) anisotropy of the honeycomb bodies and correspondingly improved ratios of axial CTE to tangential CTE of the honeycomb bodies.

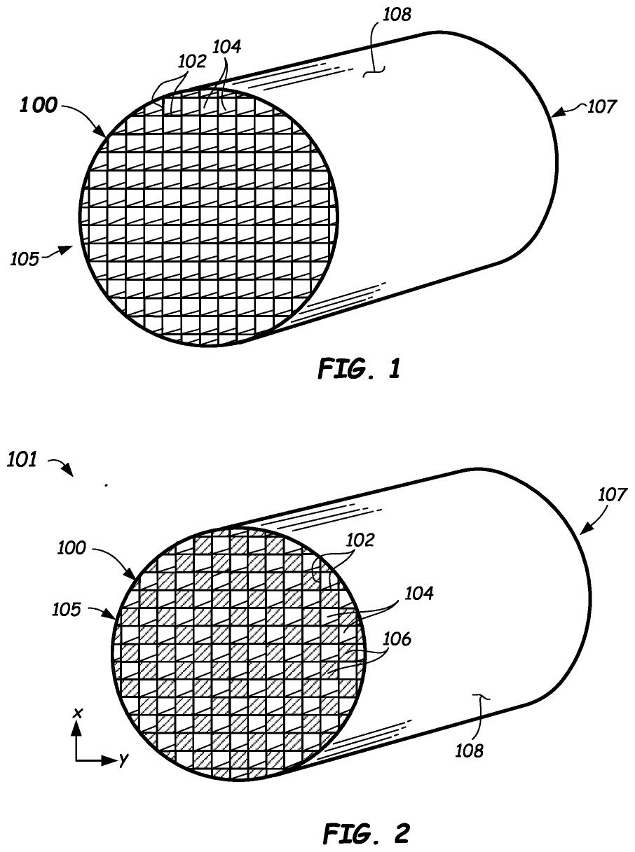

A honeycomb body 100 is illustrated in FIGS. 1 and 2. The honeycomb body 100 comprises intersecting walls 102 that form a plurality of channels 104. The channels 104 extend axially through the honeycomb body 100 and can be parallel to one another so as to extend from a first end 105 to a second end 107. A skin 108 can be formed on an outside peripheral surface of the green honeycomb body 100.

In some embodiments, such as shown in FIG. 2, the ceramic honeycomb body 100 can be plugged with plugs 106 to form a plugged ceramic honeycomb body 101. Plugging with plugs 106 can be performed using any suitable plugging process and plugging material. Some channels 104 can be plugged on the first end 105, while some channels 104 not plugged on the first end 105 can be plugged on the second end 107. Any suitable plugging pattern can be used. For example, alternating ones of the channels 104 can be plugged at the opposite ends 105, 107 to arrange the plugged ceramic honeycomb body 101 as a wall flow filter, e.g., for filtering particulate matter from the exhaust stream of a combustion engine.

In particular, the aluminum titanate-containing particles according to embodiments disclosed herein comprise a conglomerate of multiple partial grains. Partial grains are grains that have been fractured and constitute less than a full grain. As described herein, the partial grains in each conglomerate can have different orientations, such that the AT-containing particles (e.g., each comprising multiple grains) correspondingly have multiple grain orientations. Thus, since each of the AT-containing particles comprises multiple different grain orientations (and the grains of each AT-containing particles are bonded to each other at these different orientations), the grains cannot be aligned predominately with respect to a single orientation (e.g., the axial or extrusion direction during a honeycomb extrusion process).

The aluminum titanate-containing particles can comprise aluminum titanate and/or a solid solution of aluminum titanate and magnesium dititanate. In some embodiments, the aluminum titanate-containing particles are substantially pure, e.g., comprising greater than or equal to 98 wt % of aluminum titanate and/or a solid solution of aluminum titanate and magnesium dititanate. In some embodiments, the aluminum titanate-containing particles comprise less than 25 wt % of magnesium dititanate.

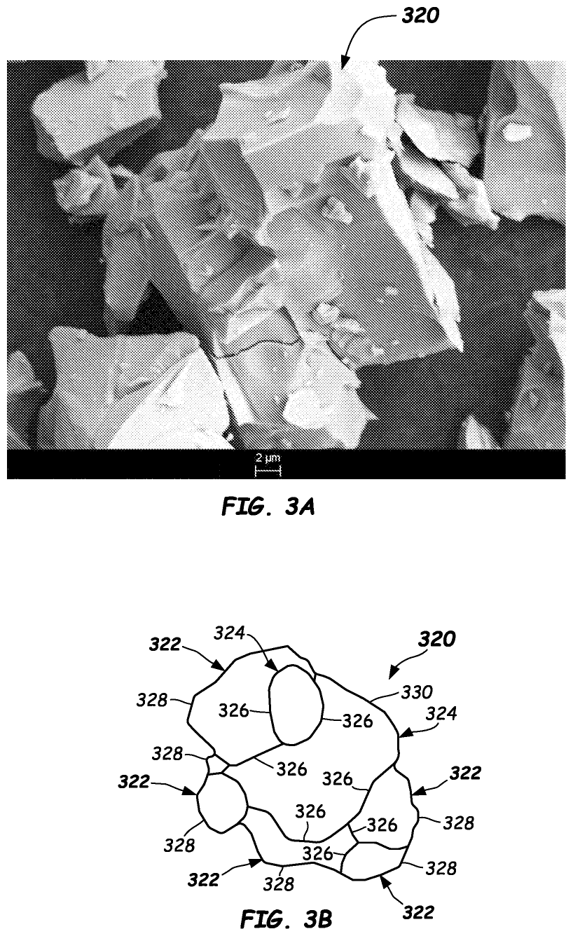

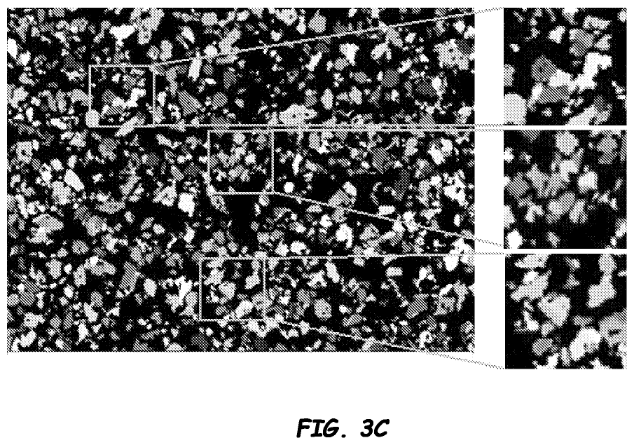

The aluminum titanate-containing particles according to embodiments of this disclosure comprise conglomerates of multiple partial grains of aluminum titanate. Partial grains, as described herein, are grains that have been fractured (e.g., mechanically cleaved or broken) and thus constitute less than a full grain. Representative aluminum titanate-containing particles 320 are shown in FIGS. 3A-3C. As described herein, a substantial amount of the outer surface of the particles 320 comprises fractured surfaces which are formed at least partially by intragranular cracking of the grains. In this way, intragranular cracking produces partial, or fractured grains. In contrast, intergranular cracking (cracking along the grain boundary between adjacent grains), does not produce partial grains but instead separates discrete grains from each other while preserving the shape and size of the grain. FIG. 3B illustrates a schematic of a cross-section of a representative one of the aluminum titanate-containing particles 320. The aluminum titanate-containing particle 320 comprises a conglomerate of partial grains 322. The particle 320 can also comprise at least some full grains 324 (i.e., grains that have not been fractured).

The partial grains 322 comprise some bonds to other partial grains 322 or to full grains 324 at boundaries between the grains. The partial grains 322 further comprise fractured grain surfaces 328, which are surfaces that were cracked, broken, or otherwise fractured. As described herein below, the fractured grain surfaces 328 can result from a milling operation that results in the partial grains 322 breaking along intragranular microcracks, with the intragranular microcracks formed as a result of firing and then cooling a ceramic body from which the particles 320 are formed. As described herein, the intragranular microcracks are formed through the grain and/or transversely through grain boundaries, as opposed to an intergrain crack or fracture being along the grain boundary 326. Thus, the outer surface of the aluminum titanate-containing particle 320 comprises at least some partial grains 322 that comprise fractured grain surfaces 328. The aluminum titanate-containing particle 320 can also comprise some unfractured (e.g., smooth) outer grain surfaces 330 that did not border other grains but instead bordered pores that were formed in the ceramic body from which the particles 320 were formed (e.g., the ceramic body 318 discussed below). In some embodiments, a large percentage (e.g., greater than 50% or even greater than 75%) of the surface area of the aluminum titanate-containing particle 320 comprises fractured grain surfaces 328 of partial grains 322.

As described herein, the AT particles 320 can be formed as conglomerates of partial AT grains by forming an AT-forming batch mixture into a green ceramic body, heating the green body to form a ceramic body by growing and sintering together grains of aluminum titanate, intragranularly microcracking the AT grains (e.g., due to anisotropic contraction of the aluminum titanate material upon cooling), and then breaking the ceramic body along the intragranular microcracks. According to embodiments disclosed herein, intragranular microcracking can be achieved by inclusion of a sintering aid in the AT-forming batch mixture that promotes a strong bond between grains, therefore causing intragranular micocracking preventing the material from shrinking up contraction during cooling. As used herein, the term “sintering aid” refers to an inorganic material that enables faster diffusion of species for ceramic phase development and promotion of crystal growth. As described herein, the sintering aids also may also at least partially melt or liquify during firing of the aluminum titanate, thereby creating a liquid “glue” or bonding agent that coats crystal surfaces and provides an additional bonding mechanism between adjacent ceramic particles.

The sintering aid can be selected such that the bonds at inter-grain boundaries 326 between the grains 322, 324 are effectively stronger than the ceramic material of the grains themselves. In this way, firing and subsequent cooling of the ceramic body 316 results in the formation of microcracks through the grains (intragranular cracking), as opposed to the formation of cracks along the grain boundaries (intergranular cracking). The intragranular cracks may also extend transversely through the grain boundaries (i.e., as opposed to along the grain boundaries). Without being bound by theory, it is postulated that the addition of the sintering aid forms a bonding layer at the grain boundaries that is strong enough (e.g., stronger than that of the grains themselves) to cause the grains to intragranularly microcrack upon cooling due to the high anisotropy in thermal expansion that is exhibited by aluminum titanate.

FIG. 3C illustrates an electron backscatter diffraction (EBSD) image of a plurality of aluminum titanate-containing particles 320 formed by intragranular microcracking according to embodiments disclosed herein. In FIG. 3C, different colors represent AT grains that are oriented at least 5° from each other. Accordingly, from FIG. 3C it can be seen that the majority of AT particles 320 are formed as conglomerates of multiple different grains bonded together at grain boundaries (in contrast with intergranularly microcracked materials that would yield monogranular particles fractured along grain boundaries).

As described herein, the formation of the AT particles 320 as multigrain conglomerates assists in randomizing the orientation of the grains (i.e., each AT particle 320 having multiple different grains at multiple different orientations), which prevents the grains from being aligned with respect to a single orientation, regardless of how the particles as a whole are oriented. Accordingly, this results in a reduction of the peak intensity ratio (PIR) of the aluminum titanate material of honeycomb bodies produced from the AT particles 320. In contrast, single grain particles (e.g., resulting from breaking particles along intergranular microcracks) results in higher values of PIR, which corresponds to higher anisotropy and less desirable ratios between axial and tangential CTE of the ceramic honeycomb bodies. For example, single grains of monogranular particles tend to align during extrusion through the narrow slots of an extrusion die, while multigrain conglomerates have grains in multiple orientations, and are therefore not so aligned. A reduction in the PIR advantageously improves the isotropy, and therefore reduces the difference in expansion during use of the honeycomb body.

Various methods of manufacturing the aluminum titanate-containing particles comprise forming a batch mixture from a plurality of inorganic sources and organic materials, forming a ceramic body from the batch mixture, and the breaking the ceramic body to form the aluminum titanate-containing particles. In particular, the aluminum titanate-containing particles that are formed by breaking the ceramic body can be used as a raw material in a subsequent honeycomb-forming batch mixture to form a green honeycomb body. In some embodiments, the AT particles are used directly without further processing, while in other embodiments further processing steps such as sieving can be employed.

Accordingly to embodiments disclosed herein, a batch mixture of inorganic materials for forming the AT particles can comprise an alumina source, a titania source, an optional magnesia source, and a sintering aid comprising at least one of clay, talc, or cordierite. The alumina source can comprise hydrated alumina (e.g., mono- and/or trihydrated), calcined alumina, or magnesium aluminate (spinel), for example. Other suitable sources of alumina can be used. The alumina source can comprise a median particle diameter of from 1 μm to 16 μm, or even from 2 μm to 12 μm, for example. In certain embodiments, the median particle diameter of the alumina source is between 8 μm and 12 μm.

The alumina source can be present in any amount suitable for producing the desired aluminum titanate-containing composition. In various embodiments, the alumina source can provide alumina in the batch mixture in at least 35 wt % of the total weight of the inorganic portion of the batch mixture. In some other embodiments, the alumina source provides alumina in the batch mixture of at least 38 wt % of the total weight of inorganic portion of the batch mixture. For example, in certain embodiments, the alumina source provides alumina in the batch mixture in an amount from 38 wt % to 45 wt %, or even 38 wt % to 42 wt % of the total inorganic portion of the batch mixture. The alumina source can preferably be free or substantially free of silica, e.g., not contain greater than 1.0 wt % of silica as an impurity.

In various embodiments, the titania source comprises one or more inorganic compounds containing titanium. Non-limiting sources of titania include, for example, titanium dioxide, such as rutile phase titanium dioxide or anatase phase titanium dioxide. The titania source should preferably be free or substantially free of silica, e.g., not contain greater than 1.0 wt % of silica as an impurity.

The titanium source can be present in any amount suitable for producing the desired aluminum titanate-containing composition. In various embodiments, the titania source provides titania in the batch mixture in at least 45 wt % of the total weight of the inorganic materials of the batch mixture. In some embodiments, the titania source provides titania in the batch mixture of at least 50 wt % of the total weight of inorganic portion of the batch mixture. For example, in certain embodiments, the titania source provides titania in the batch mixture of from 48 wt % to 54 wt %, or even 50 wt % to 54 wt %, of the total inorganic portion of the batch mixture. The titania source can have a median particle size of less than 10.0 μm, for example. In certain embodiments, the median particle diameter of the titania source is from 0.1 μm to 5.0 μm or even from 0.1 μm to 0.2 μm, for example.

The magnesia source can comprise MgO, Mg(OH)₂, or magnesium aluminate (spinel), for example. The magnesia source can be present in any amount suitable for producing the desired aluminum titanate-containing composition. In various embodiments, the magnesia source provides magnesia in the batch mixture that is at least 2.0 wt % of the total weight of the inorganic portion of the batch mixture. In some other embodiments, the magnesia source provides magnesia in the batch mixture that is at least 5.0 wt % of the total weight of inorganic portion of the batch mixture. For example, in certain embodiments, the magnesia source provides magnesia in the batch mixture that is from 0.0 wt % to 7.0 wt %, or even from 2 wt % to 7 wt % in some embodiments, based on the total inorganic portion of the batch mixture. The magnesia source can have a median particle size of less than 40 μm, for example.

As described herein, silica-containing materials that also assists in bonding grains of AT together during firing can be selected as a sintering aid. In this way, the grain boundaries (e.g., grain boundaries 326) between the grains (e.g., the partial and/or full grains 322, 324) of the AT-containing particles (e.g., AT-containing particles 320) are silica-containing (silica rich) bonding layers. Surprisingly, it has been found that only certain silica-containing materials, namely, clay, talc, and cordierite, are particularly well suited for promoting the intragranular cracking useful for forming the AT-containing particles as conglomerates of partial grains. For example, as described herein, silica by itself, as well as other silica-containing materials such as mullite and CaSiO₃, do not promote high levels of intragranular microcracking, which leads to the manufacture of honeycomb bodies with comparatively higher anisotropy.

Each of clay, talc, and cordierite as sintering aids bring silica as either a compound with magnesium or as a compound with aluminum. The magnesium and aluminum can be effectively absorbed into the aluminum titanate pseudobrookite phase upon firing, but the silica can be only slightly absorbed. The inventors have recognized that the amount of the clay, talc, or cordierite sintering aid should be limited because having too much of such a sintering aid can result in too much silica remaining unabsorbed in the aluminum titanate particles. The inventors discovered that this can cause unexpected and undesirable property shifts in the final extruded ceramic honeycomb bodies, such as, for example, higher CTE, or other undesirable attributes in the ceramic honeycomb bodies produced using the aluminum titanate particles. Accordingly, the silica content in the sintering aid can be limited, e.g., to the wt % values given herein and/or to those wt % values that yield satisfactorily low formation of crystalline cordierite. Moreover, the alumina source, the titania source, and the magnesia source used in forming the batch mixture for forming the aluminum titanate-containing particles is also limited so that the batch mixture for forming the aluminum titanate-containing particles contains less than or equal to 1.8 wt % of silica based upon the total weight of inorganics in the batch mixture.

For example, in some embodiments the sintering aid is provided in the first batch mixture (for making the AT-particles) in an amount of less than or equal to 5 wt %, 4 wt %, 3 wt %, 2 wt %, 1 wt %, or even 0.5 wt % based upon the total weight (100 wt %) of the inorganic materials present in the batch mixture. In some embodiments, the sintering aid is provided in an amount of at least 0.1 wt %, 0.2 wt %, 0.3 wt %, 0.4 wt %, 0.5 wt %, or even 1.0 wt % based upon the total weight of the inorganic materials present in the batch mixture. In some embodiments, the sintering aid is present in the batch mixture in an amount of about 1 wt %, from 0.1 wt % to 5 wt %, from 0.1 wt % to 4 wt %, from 0.1 wt % to 3 wt %, from 0.1 wt % to 2 wt %, from 0.1 wt % to 1 wt %, from 0.2 wt % to 5 wt %, from 0.2 wt % to 4 wt %, from 0.2 wt % to 3 wt %, from 0.2 wt % to 2 wt %, from 0.2 wt % to 1 wt %, from 0.3 wt % to 5 wt %, from 0.3 wt % to 4 wt %, from 0.3 wt % to 3 wt %, from 0.3 wt % to 2 wt %, from 0.3 wt % to 1 wt %, from 0.4 wt % to 5 wt %, from 0.4 wt % to 4 wt %, from 0.4 wt % to 3 wt %, from 0.4 wt % to 2 wt %, from 0.4 wt % to 1 wt %, from 0.5 wt % to 5 wt %, from 0.5 wt % to 4 wt %, from 0.5 wt % to 3 wt %, from 0.5 wt % to 2 wt %, from 0.5 wt % to 1 wt %, from 1 wt % to 5 wt %, from 1 wt % to 4 wt %, from 1 wt % to 3 wt %, or from 1 wt % to 2 wt %, based upon the total weight of the inorganic materials present in the batch mixture.

Alternatively or additionally, the amount and type of the sintering aid can be selected such that firing the particle-forming batch mixture results in the formation of less than 1 wt % cordierite, less than 0.5 wt % cordierite, less than 0.1 wt % cordierite, or even the formation of essentially no or even no cordierite (0 wt %), with respect to the total weight of the inorganic materials present in the batch mixture. In this way, in some embodiments, the amount of sintering aid can be greater than 5 wt % if the formation of a secondary cordierite phase is so limited.

As shown in Table 1 below, the wt % of the sintering aid can be adjusted based on the molar proportion of silica in the material. For example, the values of Table 1 can be considered as a maximum or upper bound that should not be surpassed unless the particular batch mixture can accommodate such percentages without undue formation of undesired secondary crystalline phases during firing (e.g., the formation of less than 1.0 wt % cordierite).

TABLE 1
Silica-Content Adjusted Wt % for each of clay, talc, and cordierite

| | Silica-Content |
|---|---|
| Sintering Aid | Adjusted wt % |
| Clay - Kaolinite (Al₂Si₂O₅(OH)₄) | 5.0 |
| Talc (Mg₃Si₄O₁₀(OH)₂) | 3.7 |
| Cordierite (Mg₂Al₄Si₅O₁₈) | 4.5 |

In some embodiments, the sintering aid comprises clay, such as kaolin clay. In the case of clay as the sintering aid, too much silica in the batch mixture from the clay can result in high CTE in ceramic honeycomb bodies 100 manufactured using the aluminum titanate-containing particles that are produced. The clay used in the batch mixture can comprise a median particle diameter of less than 40 μm, for example. However, since the sintering aid is intended to liquify, the particle size can vary in other embodiments. The clay can be kaolin clay, either calcined or uncalcined. Other forms of clay that can be used are montmorillonite, smectite, or chlorite clay, as well as other forms of clay. In some embodiments, the amount of clay is 5.0 wt % or less (as summarized in Table 1), 4.0 wt % or less, 3.0 wt % or less, based upon the total weight of inorganics present in the batch mixture

In some embodiments, the sintering aid can comprise talc. The talc can comprise a median particle diameter from 5μm to 40 μm, such as from 5μm to 20 μm, for example. As above, since the sintering aid is intended to liquify, other sizes can be used. Due to the proportionally greater amount of silica in talc as compared to clay, a batch mixture may be able to accommodate a relatively lesser amount of talc than clay, e.g., 4.0 w % or less, 3.7 wt % or less (as summarized in Table 1), 3.0 wt % or less, 2.0 wt % or less, or even 1.0 wt % or less, based upon the total weight of inorganics present in the batch mixture.

In some batch mixtures, the sintering aid can comprise cordierite. As with clay and talc, too much cordierite can result in a level of silica that results in seeding of unwanted crystalline phases (e.g., crystalline cordierite phase) in the fired ceramic honeycomb bodies 100 manufactured using the aluminum titanate-containing particles. When the sintering aid comprises cordierite, the median particle diameter can be less than 50 μm, although other particles sizes can be utilized as the cordierite is intended to liquify during firing. In certain other embodiments, the sintering aid can comprise cordierite having a median particle diameter from 1μm to 25 μm, for example. Due to the proportionate amount of silica in cordierite as compared to talc and clay, a batch mixture may be able to accommodate a relatively lesser amount of cordierite than clay but greater amount than talc, e.g., 5.0 wt % or less, 4.5 wt % or less (as summarized in Table 1), 4.0 w % or less, 3.0 wt % or less, 2.0 wt % or less, or even 1.0 wt % or less, based upon the total weight of inorganics present in the batch mixture.

After mixing together the batch mixture, an intermediary or first green body can be formed from the batch mixture. The first green body can be fired to make an intermediary or first ceramic body, which first ceramic body is broken apart to create the AT particles as described above. As noted herein and described in more detail below, the resulting AT particles can be used to form a second batch mixture (or honeycomb batch mixture) that is used to create a second green body (or honeycomb green body) that is fired to create a second ceramic body (or honeycomb ceramic body).

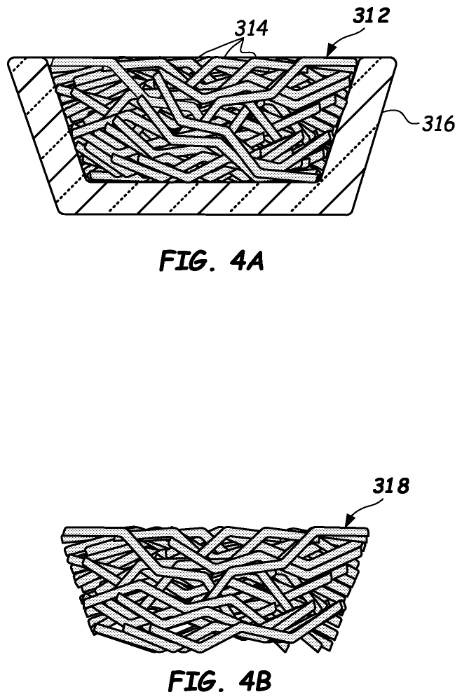

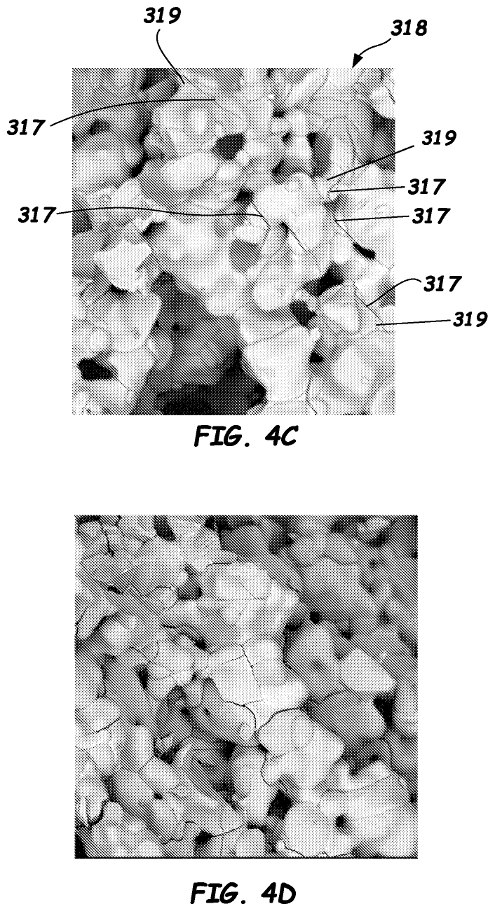

Since the first ceramic body formed by firing the green body is intended to be broken apart, the first green body can be formed to have any suitable form, shape, or structure. For example, as shown in FIG. 4A, a green body 312 can be formed from a collection of extruded spaghetti strands 314 that are placed in a mold or container 316, such as a ceramic vessel. The spaghetti strands 314 can have a diameter D of greater than or equal to 1.0 mm and can have a length L, wherein L>>D. In certain embodiments, the spaghetti strands 314 have a diameter D of greater than or equal 1.0 mm and less than or equal to 20 mm, for example. In some embodiments, L is 10 times D or more. The container 316 can be made from an alumina ceramic, for example.

In some embodiments, the green body 312 is formed as a rod, bar, strand, block, tube, or combinations thereof. In some embodiments, the green body 312 has an initial shape or size and is cut or otherwise separated into chunks or pieces for firing. In some embodiments, the green body 312 is formed by granularization to form a plurality of spheroids, globules, or pellets. Other forms of pelletizing can be used. The globules, pieces, or pellets can be placed in a suitable container for firing. Optionally, the globules, pieces, or pellets can be placed in a rotary calcining apparatus to accomplish the firing.

Once the first green body is formed, the first green body is fired to form a first ceramic body, i.e., a reacted and sintered aluminum titanate body. For example, with respect to FIGS. 4A-4B, the green body 312 can be fired to formed a ceramic body 318. The firing can comprise heating in a suitable furnace, kiln, rotary calcining apparatus, or other device arranged to subject the first green body to conditions, e.g., time and temperature, sufficient to convert the first green body into a ceramic body. As the AT particles are formed by breaking apart the ceramic body, the composition of the ceramic body is the same as that of the AT particles as described herein.

During firing of the green body 312, the green body 312 can be heated at a predefined heating ramp rate. The heating ramp rate during the firing is, in some embodiments, greater than 1° C./min. In certain embodiments, the heating rate during the firing is greater than 5° C./min, greater than 10° C./min, or even greater than 20° C./min. In certain embodiments, the heating rate during the firing is greater than 2° C./min and less than 20° C./min.

The firing of the first green body (e.g., the green body 312) can be carried out at a top soak temperature. For example, the first green body can be fired at a top soak temperature of at least 1350° C., and for example from 1350° C. to 1700° C. in some embodiments. In other embodiments, the first green body can be fired at a top soak temperature of at least 1475° C., and for example, the top soak temperature during firing can be from 1475° C. to 1625° C. Higher firing temperature can result in advantages of less firing time.

In some embodiments, the firing of the first green body is carried out at the top soak temperature for a firing time of from 1 hour to 10 hours, or even from 2 hours to 6 hours. The firing time is the time the first green body is held at the maximum or top soak temperature, and does not include the time spent ramping up to the top soak temperature, or the time spent cooling the ceramic body from the top soak temperature. Relatively-high top soak temperatures coupled with short firing time can assist in producing low-cost, aluminum titanate-containing particles. The firing time and top soak temperature can be used to at least partially control the size of the produced AT grains, with higher temperatures and/or shorter firing times producing smaller grains and lower temperatures and/or longer firing times producing larger grains. In various embodiments of the disclosure, the aluminum titanate-containing ceramic body has grains of a particular size range based on the firing time and the peak soak temperature during the firing.

At the end of the top soak, the ceramic body (e.g., the ceramic body 318) can be cooled at a suitable cooling rate, such as greater than 2° C./min. In certain embodiments, the cooling rate after the firing is greater than 10° C./min, greater than 50° C./min, or even greater than 100° C./min, which is similar to a sudden quenching. As described herein, the cooling can be performed such that it produces microcracks through the grains (i.e., intragranular cracks) which become fractured surfaces of the partial grains of the aluminum-titanate particles 320. For example, the cracking may result from high anisotropy in expansion that is exhibited by aluminum titanate during cooling. As described herein, by at least partially forming the boundaries between AT grains with the sintering aid, the boundary can be stronger than the grains themselves, thereby promoting intragrain cracking (e.g., through the grains and/or transversely through the grain boundaries) as opposed to intergrain cracking (e.g., along the grain boundaries).

As with the green body 312, there is no particular form or shape of the ceramic body 318 that is required. However, as the AT particles are formed from the ceramic body 318, the composition of the ceramic body 318 should be the same as that intended for the AT particles, e.g., substantially-pure aluminum titanate and/or solid solution of aluminum titanate and magnesium dititanate. For example, the ceramic body 318 and the resulting aluminum titanate-containing particles 320 derived from the ceramic body 318 have greater than 98 wt % of aluminum titanate and/or a solid solution of aluminum titanate and magnesium dititanate based upon a total (100 wt %) of inorganics present in the ceramic body 318. Further, according to various embodiments, the aluminum titanate containing particles can have a pseudobrookite crystal structure.

FIG. 4C is a scanning electron microscope (SEM) image of a surface of a portion of a first ceramic body (e.g., the ceramic body 318) that shows significant intragrain cracking. The ceramic body of FIG. 4C was formed utilizing 1 wt % talc as sintering aid (the wt % based on a total weight of inorganics in the batch mixture used to form the ceramic body). The intragranular cracks 317 are formed intragranularly, i.e., extending through the grains and/or transversely through grain boundaries 319 as opposed to along the grain boundaries 319. As shown, most (>50%) of the microcracks in the ceramic body of FIG. 4C are formed intragranularly in the ceramic body 318. In some embodiments, a majority (>50%) of the cracks forming facets of the particle 320 are intragranular.

FIG. 4D shows an SEM image of a surface of a portion of a ceramic body that is formed from aluminum titanate-containing particles that did not include a sintering aid. In contrast to FIG. 4C (which shows a ceramic body that utilized talc as sintering aid), microcracks (along which the pellet breaks into powder particles during milling or other breaking operation), are predominantly seen to occur along grain boundaries. In other words, at least a majority (>50%) of the microcracks in the ceramic body of FIG. 4D are intergrain. The intergranular microcracking of the ceramic body of FIG. 4D is in contrast to that of the ceramic body of FIG. 4C, in which the majority of microcracks are intragranular.

As described herein, it was surprisingly found that cordierite, talc, and clay produce high intragranular microcracking in aluminum-titanate ceramic bodies (e.g., as shown in FIG. 4C), which can be used to produce the AT-containing particles 320 formed as conglomerates of multiple partial grains, while the use of sintering aids comprising silica and other silica-containing materials produce high intergranular microcracking (e.g., as shown in FIG. 4D), which produces AT-containing particles that are largely single grains (monogranular). For example, it has been found by the inventors that silica and other silica-containing materials such as mullite and CaSiO₃ lead to the production of ceramic bodies that are (in comparison to the use of sintering aids comprising cordierite, clay, and/or talc) highly intergranularly microcracked, thereby resulting in the production of predominately (e.g., >50%) or even essentially only (e.g., >75%, or even >90%) single-grain aluminum titanate particles. That is, in the case with silica, mullite, CaSiO₃, or no sintering aid added, the aluminum-titanate grains simply pull apart along the grain boundaries (i.e., form intergranular microcracks) when the stresses caused by the anisotropy of the thermal expansion in the aluminum titanate are relieved during cooling.

Next, as described above, the ceramic body 318 is broken apart to form aluminum titanate-containing particles 320. The breaking action can be performed by any suitable milling device, such as a disc pulverizing device (e.g., commercially available from BICO, Inc. and others), a rotary crusher, a pin mill, a ball mill, or the like. Due to the microcracking of the AT grains of the ceramic body 318 upon cooling, the aluminum titanate-containing particles 320 produced from the ceramic body 318 as described herein can relatively easily be broken apart with only a small amount of applied energy. In this way, the intragranular cracking of the ceramic body 318 can be useful for forming the aluminum titanate-containing particles 320 with a predetermined particle size and/or a relatively narrow particle size distribution.

In some embodiments, the aluminum titanate-containing particles 320 naturally (that is, the particles 320 as broken predominately along the intragranular microcracks) exhibit a relatively-coarse median particle diameter d₅₀ as well as a narrow particle size distribution. In some embodiments, the particle size distribution of the AT-containing particles 320 is determined, in part, based on the time and temperature of the firing of the first ceramic body. However, the particle size distribution can be further controlled, if desired, via a particle sieving step.

The median particle size (d₅₀) and/or particle size distribution of the aluminum titanate-containing particles 320 can be at least partially controlled via the processing parameters such as firing time and peak soak temperature. In some embodiments, the aluminum titanate-containing particles 320 have a median particle size (d₅₀) of 18 μm to 70 μm and a d_{f}≤1.0 upon being broken apart, where d_{f}=(d₅₀−d₁₀)/d₅₀, and d₁₀ refers to a particle size in a distribution such that 90% of particles in the distribution have a larger particle size and 10% of the particles in the distribution have a smaller particle size.

As part of the breaking of the ceramic body 318, or subsequent thereto, particle sieving can be employed. The particle sieving can be used to remove one or more particle fractions from the as-broken aluminum titanate-containing particles to yield sieved aluminum titanate-containing particles of a sieved particle size distribution that can be used as a raw material in honeycomb-forming batch mixtures. For example, the particle size distribution achieved by sieving can be useful in setting d₅₀ and/or d_{f}, as desired.

In particular, the particle sieving can be used to filter the aluminum titanate-containing particles 320 in order to provide a narrower median particle diameter range, such as from 25 μm to 55 μm in sieved aluminum titanate-containing particles. For example, after breaking the ceramic body 318, the pre reacted aluminum titanate-containing particles 320 are sieved and the particles smaller than the sieve size (e.g., “unders”) can be retained for use in the subsequent manufacture of honeycomb bodies. Particles larger than the sieve size (e.g., “overs”) can discarded, used for another purpose, and/or returned to the mill.

In some embodiments, the aluminum titanate-containing particles 320 exhibit a particle size distribution wherein d₁₀≥5 μm, or even d₁₀≥10 μm. Minimizing d₉₀ (d₉₀ referring to a particle size in a distribution such that 10% of particles in the distribution have a larger particle size and 90% of the particles in the distribution have a smaller particle size) through sieving may aid in improving extrusion quality such as by preventing high extrusion die pressures or minimizing non-knitting in walls when used as a particle in an extruded batch mixture to form a ceramic honeycomb body, e.g., the ceramic honeycomb body 100 of FIGS. 1 and 2. Having a higher value of d₁₀ may also enhance the CTE of the resultant ceramic honeycomb body 100 produced from the aluminum titanate-containing particles 320. A relatively higher value of d₁₀ may also aid in producing grains that are large enough in the ceramic honeycomb body 100 so as to have sufficient microcracking to provide enhanced (lowered) CTE.

In some embodiments, removing one or more particle fractions by sieving is carried out to produce an even narrower particle size distribution of the sieved aluminum titanate-containing particles over at least some portion of the particle size distribution. In particular, sieving can be used in some embodiments to produce a particle size distribution of the sieved aluminum titanate-containing particles having d_{f}≤0.60, where d_{f}=(d₅₀−d₁₀)/d₅₀.

In some embodiments, removing one or more particle fractions from by sieving is carried out to produce a narrow overall particle distribution of the sieved aluminum titanate-containing particles. In some embodiments, the breadth, d_{b}, of the particle size distribution satisfies d_{b}≤1.60, wherein d_{b}=(d₉₀−d₁₀)/d₅₀. Sieving, for example, can be by using a mesh of predetermined mesh or sieve size, such as a −325 or a −100 mesh screen while retaining the fraction over and/or under the sieve size. Other suitable mesh screen sizes can be used.

Tables 2A and 2B below illustrates several examples of batch mixtures useful in the formation of the aluminum titanate-containing particles 320. In the batch mixture, sources of alumina, titania, and magnesia are provided together with the sintering aid comprising talc, clay, or cordierite. As summarized in the Tables, other materials are included in the batch mixture for making the aluminum titanate-containing particles 320, such as an organic binder (e.g., methylcellulose), lubricants such as oil or fatty acid, and a liquid vehicle such as water.

TABLE 2A
Example Batch Mixtures/Conditions for AT-containing Particles

| Materials | Type | E1 | F1 | G1 | H1 | A1 |
|---|---|---|---|---|---|---|
| Alumina Source | 10 μm alumina | — | 40.35 | 40.35 | 40.35 | 40.35 |
| | 4 μm alumina | 40.35 | — | — | — | — |
| Titania Source | Titania, 0.3 μm | 52.32 | 52.32 | 52.32 | 52.32 | 52.32 |
| Magnesia Source | Magnesium Hydroxide | 7.33 | 7.33 | 7.33 | 7.33 | 7.33 |
| Total Wt % | | 100.00 | 100.00 | 100.00 | 100.00 | 100.00 |
| Sintering Aid | 17 μm talc | 1 | — | — | — | — |
| | 7 μm talc | — | 1 | 0.4 | | — |
| | Hydrous Clay | — | — | 0.5 | 1 | — |
| | 1.4 μm Cordierite | — | — | — | — | 1 |
| Organic Binder | Methylcellulose wt % SA | 1.75 | 1.75 | 1.75 | 1.75 | 1.75 |
| Liquids | Oil wt % SAP | 4 | 4 | 4 | 4 | 4 |
| | Fatty Acid wt % SAP | 1 | 1 | 1 | 1 | 1 |
| | Liquid Vehicle | 7 | 7 | 7 | 7 | 7 |
| | (Water) | | | | | |
| | wt % SAP | | | | | |
| Firing | Top Soak Temp, ° C. | 1500 | 1600 | 1600 | 1600 | 1550 |
| | Top Soak Time, hr | 4 | 4 | 4 | 4 | 4 |
| PSD | Screen Mesh Size | −325 | −100 | −100 | −100 | −100 |
| | d₁₀ (μm) | 13 | 24 | 22 | 22 | 20 |
| | d₅₀ (μm) | 26 | 54 | 49 | 45 | 43 |
| | d₉₀ (μm) | 45 | 105 | 97 | 85 | 81 |
| d_{f} = (d₅₀ − d₁₀)/d₅₀ | d_{f} | 0.50 | 0.56 | 0.55 | 0.51 | 0.53 |
| d_{b} = (d₉₀ − d₁₀)/d₅₀ | d_{b} | 1.23 | 1.50 | 1.53 | 1.40 | 1.42 |

TABLE 2B
Example Batch Mixtures/Conditions for AT-containing Particles

| Materials | Type | A2 | B1 | C1 | D1 |
|---|---|---|---|---|---|
| Alumina Source | Wt % of 10 μm alumina | 40.35 | 40.35 | 40.35 | 40.35 |
| | Wt % of 4 μm alumina | — | — | — | — |
| Titania Source | Wt % of 0.3 μm Titania | 52.32 | 52.32 | 52.32 | 52.32 |
| Magnesia Source | Wt % of Magnesium Hydroxide | 7.33 | 7.33 | 7.33 | 7.33 |
| Total Wt % | | 100.00 | 100.00 | 100.00 | 100.00 |
| | Wt % of 1.4 μm Cordierite | 1 | — | — | — |
| | Wt % of 4 μm Cordierite | — | 1 | — | — |
| | Wt % of 20 μm Cordierite | — | — | 1 | 3 |
| Organic Binder | Methylcellulose | 1.75 | 1.75 | 1.75 | 1.75 |
| Liquids | Oil | 4 | 4 | 4 | 4 |
| | Fatty Acid | 1 | 1 | 1 | 1 |
| | Liquid Vehicle (Water) | 7 | 7 | 7 | 7 |
| Firing | Top Soak Temp, ° C. | 1600 | 1600 | 1600 | 1600 |
| | Top Soak Time, hr | 4 | 4 | 4 | 4 |
| PSD | Screen Mesh Size | −100 | −100 | −100 | −100 |
| | d₁₀ (μm) | 23 | 22 | 23 | 22 |
| | d₅₀ (μm) | 49 | 49 | 47 | 50 |
| | d₉₀ (μm) | 96 | 97 | 88 | 100 |
| d_{f} = (d₅₀ − d₁₀)/d₅₀ | d_{f} | 0.53 | 0.55 | 0.51 | 0.56 |
| d_{b} = (d₉₀ − d₁₀)/d₅₀ | d_{b} | 1.49 | 1.53 | 1.38 | 1.56 |

Tables 2A-2B above illustrate example batch mixtures, firing conditions and properties for AT-containing particles according to the disclosure. The alumina source can be provided in an amount effective to provide alumina from 37 wt % to 55 wt %, or even from 39 wt % to 42 wt %, based on the total wt % of inorganics in the batch mixture. The titania source can be provided in an amount effective to provide titania at from 45 wt % to 55 wt %, or even 51 wt % to 54 wt %, based on the total wt % of inorganics in the batch mixture. The magnesia source can be provided in an amount affective to provide magnesia at from 0 wt % to 9 wt %, or even 0 wt % to 6 wt % in some embodiments, based on the total wt % of inorganics in the batch mixture.

The sintering aid can be added to the batch mixture in an amount of 5.0 wt % or less, based on the total weight of all the inorganics in the batch mixture. However, in the batch mixtures shown, the sintering aid can be added to the batch mixture in an amount of 3.0 wt % or less, 2.0 wt % or less, or even 1.0 wt % or less, based on the total weight of all the inorganics in the batch mixture. In some embodiments, using clay or talc as the sintering aid, the sintering aid can be added to the batch mixture in an amount of 1.0 wt % or less, or even 0.5 wt % or less, based on the total weight of all the inorganics in the batch mixture. Even such a small wt % can have an unexpectedly large effect on CTE of the final ceramic honeycomb body 100, as will be demonstrated below.

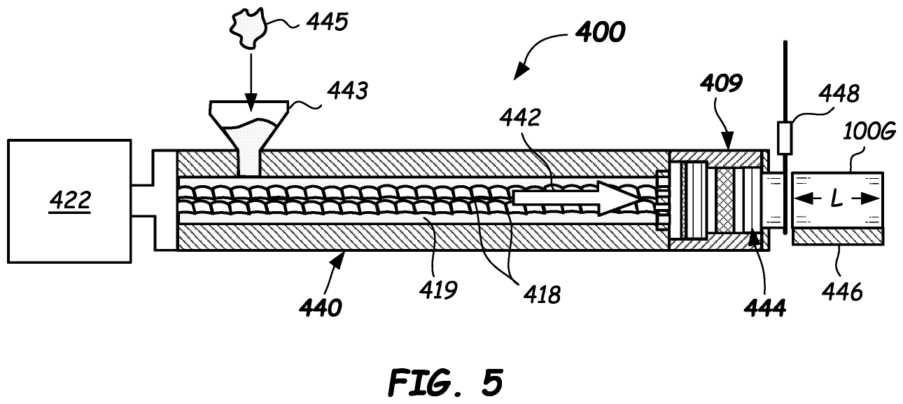

Once the AT particles 320 are formed, they can be added into a second batch mixture from which one or more honeycomb bodies are formed. The second batch mixture may be alternatively referred to herein as a honeycomb-forming batch mixture or as a honeycomb batch mixture. For example, FIG. 5 illustrates an extruder apparatus 400 that can be used in the manufacture of honeycomb bodies, although any suitable extruder apparatus can be used.

Referring to FIG. 5, the forming of a green honeycomb body 100G can be by extrusion through an extrusion die 444. The forming process can comprise any suitable extrusion process and can be performed using the extrusion die 444 arranged with the features of any suitable extrusion die as part of the extruder apparatus 400. For example, the extruder apparatus 400 can be a twin-screw extruder as described herein, or optionally a hydraulic ram extrusion press, or any other suitable extruder apparatus.

As illustrated in FIG. 5, the extruder apparatus 400 can comprise a barrel 440. The barrel 440 can be monolithic or it can be formed from a plurality of barrel segments connected successively in the longitudinal (e.g., axial) direction 442 as depicted by the directional arrow shown. The one or more chamber portions extend through the barrel 440 in the longitudinal direction 442 between an upstream side and a downstream side of the extruder apparatus 400. At the upstream side, a material supply port 443, which can comprise a hopper or other material supply structure, can be provided to supply a honeycomb-forming batch mixture 445 comprising the aluminum titanate-containing particles 320 into the extruder apparatus 400.

Batch mixture 445 can be introduced to the extruder apparatus 400 continuously or intermittently. The extrusion die 444 in accordance with various embodiments described herein is coupled at the downstream side of the barrel 440 and is configured as a die assembly 409 to extrude the batch mixture 445 into a desired shape of the green honeycomb extrudate, which can have the extruded cross-sectional configuration of the green honeycomb body 100G. The cross-sectional configuration of the extrusion die 444 and the green honeycomb body 100G may also correspond to that of the ceramic honeycomb body 100 of FIG. 1, since the green honeycomb body 100G can be converted into the ceramic honeycomb body 100 by firing as described herein. The extrusion die 444 can be coupled to the barrel 440 by any suitable means, such as bolting, clamping, or the like. The extrusion die 444 can be preceded by other extruder structures, such as a generally open cavity, a particle screen, screen support, a homogenizer, or the like to facilitate the formation of suitable flow characteristics, e.g., a steady plug-type flow front before the batch mixture 445 reaches the extrusion die 444.

As shown in FIG. 5, a pair of extruder screws 418 are mounted in the barrel 440. The pair of extruder screws 418 are rotatably mounted and can be arranged generally parallel to each other, as shown. The pair of extruder screws 418 can be coupled to a driving mechanism 422 located outside of the barrel 440 for rotation in the same or different directions. The pair of extruder screws 418 can be coupled to a single driving mechanism (as shown) or optionally to individual driving mechanisms. The pair of extruder screws 418 can operate to move the batch mixture 445 through the barrel 440 with pumping and mixing action in the longitudinal direction 442, which also corresponds to the extrusion direction. Further supporting structure (not shown) can be provided to support the pair of extruder screws 418 along their lengths. Such support structure can comprise perforations or holes therein to allow the batch mixture 445 to flow there through.

The batch mixture 445 exits the extruder apparatus 400 from the extrusion die 444 as green honeycomb extrudate. Upon exiting the extruder apparatus 400 in the longitudinal direction 442, the green honeycomb extrudate can be cut by a suitable cutting implement 448, such as a rotating saw blade, laser, wire, and/or other suitable cutting implement. The green honeycomb extrudate is cut to a desired length L and forms a green honeycomb body 100G which can then be transported on a suitable tray, guide, rail, or conveyor 446. The green honeycomb body 100G can be transported to a dryer apparatus dried. After drying, the green honeycomb body 100G can be subsequently fired to form a porous ceramic honeycomb body, such as a porous ceramic honeycomb body 100 shown in FIG. 1. If desired, the green honeycomb body 100G or the ceramic honeycomb body 100 can also be plugged to form the plugged honeycomb body 101 as shown in FIG. 2.

In some embodiments described herein, the skin of the green honeycomb bodies 100G (corresponding to the skin 108 of the ceramic honeycomb body 100) can be co-formed from the same batch mixture 445 and at the same time as the intersecting walls of the green honeycomb body 100G (corresponding to the walls 102 of the ceramic honeycomb body 100).

The honeycomb-forming batch mixture 445 can be a mixture containing the aluminum titanate-containing particles 320 either after sieving or as-broken directly after a milling or other breaking operation. In addition to the AT particles 320, the batch mixture 445 can comprise other inorganic particles (e.g., to form secondary ceramic phases, such as to assist in bonding of the AT particles into the ceramic honeycomb body 100), organic materials such as a methylcellulose organic binder (e.g., to temporarily hold the shape of green honeycomb body 100G before firing), a liquid vehicle such as water (e.g., to provide rheological characteristics to assist in mixing and extrusion), optionally a pore former (e.g., to provide pores in the ceramic honeycomb body 100 after firing), and/or other processing additives such as oils, plasticizers, etc. (e.g., to assist in the extrusion process).

The honeycomb-forming batch mixture 445 can comprise the aluminum titanate-containing particles 320 together with other inorganic particulate materials in proportions selected to produce the desired ceramic phase composition of the ceramic honeycomb body 100. As a result of the forming of the green honeycomb body 100G from the honeycomb-forming batch mixture 445, in some embodiments, the honeycomb green body 100G comprises the aluminum titanate-containing particles (comprising a conglomerate of multiple partial grains), an alumina source, and a silica source. For example, in one embodiment, cordierite is produced as a secondary phase in the ceramic honeycomb body 100 to assist in bonding the AT material of the aluminum titanate-containing particles 320 together, such as by the addition of an alumina source, a magnesia source, and a silica source to the honeycomb-forming batch mixture 445. However, other secondary ceramic phases to assist in bonding or other structural properties or characteristics can be optionally formed such as an alkali or alkaline earth feldspar. Other ceramic phases, such as phases including sodium, calcium, strontium, potassium, zirconium, or cerium can be present in combination with the bonding phase(s).

The dried green honeycomb body 100G after forming by extrusion advantageously comprises an axial peak intensity ratio (PIR) of the pseudobrookite phase of less than 0.50 in its dried state. Axial peak intensity ratio (PIR) of the pseudobrookite phase is measured using x-ray diffraction (XRD) of the extruded body (green or fired) polished surface. Axial PIR measurements are made by orienting the open honeycomb surface to the beam. The peak intensity of the (002) and (200) pseudobrookite crystal planes (space group 63, Bbmm, PDF 41-258) are compared using the formula:

PIR=I(002)/(I(002)+I(200))

where I is the intensity of the respective peak. A completely random orientation of the pseudobrookite phase would be hypothetically PIR=0.29. Green as used herein means dried to contain less than 5% water by weight. In some embodiments, the PIR in the axial direction of the pseudobrookite phase can be PIR≤0.47, PIR≤0.45, PIR≤0.43, or even PIR≤0.42. The lower the PIR in the axial direction, the less the anisotropy in the ceramic honeycomb body 100.

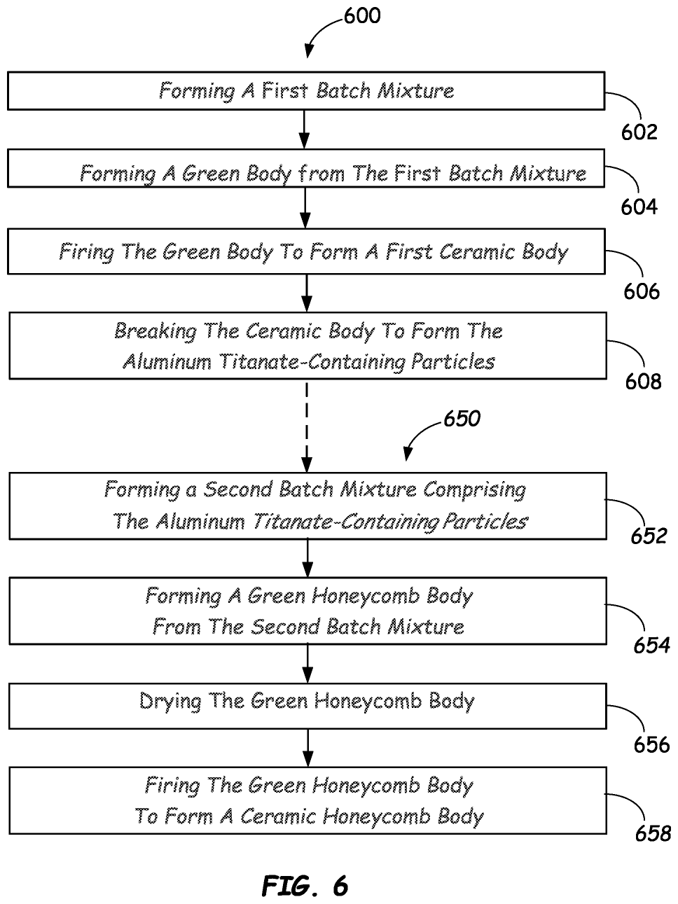

FIG. 6 illustrates a method 600 for forming AT-containing particles that comprise conglomerates of multiple partial grains bonded together (e.g., the AT particles 320 comprising partial grains 322 bonded at grain boundaries 326). At step 602, a first batch mixture is formed of aluminum titanate precursor particles, as well as an organic binder (e.g., methylcellulose) and a liquid vehicle (e.g., water). Extrusion aids, such as oils or fatty acids can be included. The first batch mixture can comprise pore former particles if desired. As described herein, the first batch mixture also comprises a sintering aid that comprises cordierite, clay, and/or talc. In some embodiments, the amount of sintering aid in the batch mixture is between 0.1 wt % and 5 wt %, based on a total weight of inorganics in the first batch mixture. In some embodiments, the amount of sintering aid is from 0.1 wt % to 3.0 wt %, based on the total weight of inorganics in the first batch mixture. In some embodiments, the amount of sintering aid is selected such that less than 1 wt %, less than 0.5 wt %, or even less than 0.1 wt % of a cordierite phase is present in a resulting ceramic body when a first green body formed from the first batch mixture is ultimately fired.

In step 604, the first batch mixture is formed into a first green body (e.g., the first green body 316). In step 606, the first green body is fired to form a first ceramic body (e.g., the first ceramic body 318). The first green body can be dried before firing. Since the first ceramic body is intended to be broken into a powder of AT-containing particles, the first green body and resulting first ceramic body can take any suitable form, such as a rod, block, brick, disk, plate, strand, or combinations thereof. In one embodiment, the first green body comprises a plurality of strands that are shaped into a block in a vessel before firing.

Due to the anisotropy in the aluminum titanate material of the first ceramic body, the material of the first ceramic body microcracks upon cooling after firing. As described herein, the presence of the sintering aid in the first batch mixture promotes intragranular microcracking of the material of the first ceramic body (i.e., microcracking through AT grains and/or transversely through boundaries between adjacent AT grains) as opposed to intergranular microcracking (i.e., along the grain boundaries between adjacent grains).

The first ceramic body is then broken into the AT-containing particles in step 608. In some embodiments, the first ceramic body is broken into the AT-containing particles by a milling operation. For example, the ceramic body is broken along the microcracks formed after the firing in step 606. By strengthening the area around the grain boundaries between adjacent grains, the sintering aid used in the first batch mixture also promotes any additional cracking (e.g., new fractures that are not along existing microcracks) during the breaking process to occur intragranularly. As described herein, the intragranular cracking results in the AT-containing particles being formed as conglomerates of multiple partial AT grains bonded together at one or more bonding layers formed at the grain boundaries between adjacent ones of the AT grains. Since the sintering aid in the first batch mixture comprises cordierite, talc, or clay, the bonding layer at the grain boundaries contain relatively high amounts of silica (which is otherwise an impurity in aluminum titanate).

After forming the AT particles in accordance with the method 600, the AT particles can be utilized in a method 650 for forming a ceramic honeycomb body (e.g., the ceramic honeycomb body 100). In step 502, the method 500 comprises forming a honeycomb-forming batch mixture by mixing together the aluminum titanate-containing particles described above comprising a conglomerate of multiple partial grains together with other inorganic sources. The other sources of inorganics can comprise, for example, at least an alumina source and a silica source, optionally a magnesia source, and possibly other organic ingredients.

The method 500 further comprises, in block 504, forming the honeycomb-forming batch mixture into a honeycomb green body 100G of a shape of the final honeycomb 100 as shown in FIG. 1, for example. The honeycomb green body 100G, like the ceramic honeycomb body 100, comprises intersecting walls 102 forming a plurality of channels 104. The channels 104 extend axially and can be parallel to one another so as to extend from a first end 105 to a second end 107. A skin 108 may be formed on an outside peripheral surface of the green honeycomb body 100G.

Following formation of the green honeycomb body 100G in block 504, the green honeycomb body 100G can then be dried and fired using conventional drying and firing apparatus to produce a ceramic honeycomb body 100 as is shown in FIG. 1. Upon being provided to the tray 446, the tray 446 with green honeycomb body 100G can be provided to a suitable dryer apparatus and dried, such as described in U.S. Pat. Nos. 9,335,093, 9,038,284, 7,596,885, and 6,259,078, for example. Any suitable conventional drying apparatus can be used in block 506 for drying, such as RF drying, microwave drying, oven drying, or combinations thereof. The green honeycomb body 100G can initially be cut to a desired length L by cutting implement 448 or optionally can be cut to an intermediate log length and then dried and cut to the desired length L after drying. Thus, in this instance, multiple dried green honeycomb bodies can be provided from each log.

Following the drying in block 506, the dried green honeycomb body can be fired in block 508 using conventional firing apparatus. When fired, such as in a furnace or kiln, the dried green honeycomb body made from the batch mixture 445 is transformed or sintered into a porous ceramic honeycomb body 100 as shown in FIG. 1, for example. The porous honeycomb body 100 can comprise a porous ceramic suitable for exhaust treatment or for other catalyst support or filtration purposes. For example, the porous ceramic honeycomb body 100 can comprise an aluminum titanate-containing ceramic material comprising the aluminum titanate-containing particles 320 sintered, reacted, and/or bonded together. The composition (e.g., types and amounts of ceramic phases) need not be exactly the same in the AT particles and the ceramic honeycomb body. For example, in formation of the honeycomb body 100, the AT particles can be bonded together by a bonding phase, such as a cordierite ceramic that functions as an inorganic binder that bonds together the aluminum titanate-containing particles 320. Alternate or additional secondary phases in the honeycomb body 100 include mullite, alkaline earth or alkaline feldspars, silica, or other compatible phases.

In some embodiments, at least one additional inorganic material is added in combination with the aluminum titanate-containing particles 320. Non-limiting examples of additional inorganic materials include at least an alumina source and a silica source, and can optionally include a magnesia source. In various disclosed embodiments, honeycomb-forming batch mixtures 445 comprise the aluminum titanate-containing particles along with an alumina source, a silica source, and a magnesia source.

The aluminum titanate-containing particles 320 can be provided in the honeycomb-forming batch mixture 445 in an amount of at least 50 wt %, at least 60 wt %, and at least 70 wt %, or any range including these values as end points, based on a total weight of inorganics in the batch mixture 445. In certain embodiments, the aluminum titanate-containing particles 320 can be provided in the honeycomb-forming batch mixture 445 in an amount of from 70 wt % to 90 wt %, or even from 70 wt % to 80 wt %, based on a total weight of inorganics in the honeycomb-forming batch mixture 445.

The alumina source for the honeycomb-forming batch mixture 445 can comprise any suitable aluminum-containing compound, such as calcined alumina, hydrated alumina (e.g., mono- and/or trihydrated), or spinel. In various embodiments of the disclosure, the alumina source is present in an amount ranging from 5 wt % to 34 wt %, from 10 wt % to 34 wt %, from 15 wt % to 34 wt %, from 20 wt % to 34 wt %, from 25 wt % to 34 wt %, from 30 wt % to 34 wt %, from 5 wt % to 30 wt %, from 10 wt % to 30 wt %, from 5 wt % to 25 wt %, from 5 wt % to 20 wt %, from 5 wt % to 15 wt %, from 10 wt % to 25 wt %, from 10 wt % to 20 wt %, from 10 wt % to 15 wt %, from 11 wt % to 13 wt %, or even from 11.5 wt % to 12.5 wt %, based on the total weight of inorganics in the honeycomb-forming batch mixture 445.

The optional magnesia source in the honeycomb-forming mixture 445 can be any suitable magnesium-containing compound. For example, the magnesia source can be magnesium hydroxide, talc, calcined talc, magnesium oxide, magnesium carbonate, magnesium aluminate spinel, brucite, or a combination thereof. The magnesia source is added to the honeycomb-forming batch mixture 445 along with the alumina source and the particles. The talc and calcined talc are sources of silica in addition to magnesium, and in some embodiments are added in limited amounts. In various embodiments of the disclosure, the magnesia source can be present in an amount ranging from 0 wt % up to 10 wt %, such as from 2 wt % to 10 wt %, or from 3 wt % to 10 wt %, 4 wt % to 10 wt %, 5 wt % to 10 wt %, 6 wt % to 10 wt %, 7 wt % to 10 wt %, 8 wt % to 10 wt %, 9 wt % to 10 wt %, 4 wt % to 5 wt %, 4 wt % to 6 wt %, 4 wt % to 7 wt %, or 4 wt % to 8 wt %, based on the total weight of inorganic compounds in the batch mixture.

According to some embodiments, the honeycomb-forming batch mixture 445 comprises a silica-containing compound. For example, a silica (SiO₂), clay, mullite, or talc may be used. In certain embodiments, the median particle diameter d₅₀ of the silica source can be from 0.01 μm and 100 μm, for example. Other particles sizes can be used. The silica source can be present in the honeycomb batch mixture 445 in an amount ranging from 0 wt % up to 12 wt %, such as from 4 wt % to 12 wt %, from 4 wt % to 11 wt %, from 4 wt % to 10 wt %, from 4 wt % to 9 wt %, from 4 wt % to 8 wt %, from 4 wt % to 7 wt %, from 4 wt % to 6 wt %, from 4 wt % to 5 wt %, from 5 wt % to 12 wt %, from 6 wt % to 12 wt %, from 7 wt % to 12 wt %, from 8 wt % to 12 wt %, from 9 wt % to 12 wt %, from 10 wt % to 12 wt %, from 11 wt % to 12 wt %, from 5 wt % to 11 wt %, from 5 wt % to 10 wt %, from 6 wt % to 11 wt %, or from 6 wt % to 10 wt %, based on the total weight of inorganic compounds in the batch mixture.

In order to achieve a relatively-high average bulk porosity, % P, of the ceramic material of the ceramic honeycomb body 100, e.g., % P≥40%, the honeycomb-forming batch mixture 445 can contain a suitable amount of a pore former to aid in tailoring the average bulk porosity. The selection of pore former (e.g., particle size of pore former particles) can also be useful for influencing the median pore diameter d₅₀ and the pore size distribution of the ceramic honeycomb body 100. For example, pore formers can be fugitive or other materials, which evaporate, undergo vaporization, are combined with other ingredients or otherwise at least partially change volume or are removed, e.g., by combustion, during drying and/or heating of the green honeycomb body 100G.

Any suitable pore former can be used, such as, without limitation, carbon, graphite, starch, flour (e.g., wood, shell, or nut flour), polymers such as polyethylene beads, and the like, and combinations of the aforementioned. Starches can comprise corn starch, rice starch, pea starch, sago starch, potato starch, and the like. Other suitable starches can be used.

When used, the pore former can have a median particle diameter (d₅₀) in the range of from 10 μm to 70 μm, or even from 20 μm to 50 μm. In some embodiments, combinations of graphite and starch in the honeycomb-forming batch mixture 445 can aid in providing relatively-high average bulk porosity (e.g., % P≥40%) in combination with suitable microstructural properties, while also reducing cracking during firing ramp up. The pore former as described herein is provided in the batch mixture 445 in a weight percent by superaddition (wt. % SA) based upon 100% of the weight of the inorganics present in the batch mixture 445.

In some example embodiments, the pore former can be provided in the batch mixture 445 in an amount sufficient to form ceramic honeycomb bodies 100 having 40≤% P≤70%. In some embodiments, the pore former is provided in an amount of up to 50 wt % SA, such as from 4 wt. % SA to 50 wt. % SA, wherein wt. % SA is weight percent by superaddition (SA) based on the total weight of the inorganics in the batch mixture. A suitable amount of pore former can be selected in the batch mixture 445 along with appropriate sizes of inorganics and firing cycle to achieve the desired average bulk porosity (% P).

In some embodiments, the pore former comprises a combination of starch and graphite. Embodiments can have, for example, a starch:graphite ratio of between 1.0:1.0 and 3.5:1.0. For example, in the embodiments shown in Table 3A-3F below, combinations of starch of from 3 wt. % SA to 20 wt. % SA and graphite of from 1.5 wt. % SA to 12 wt. % SA can be used in the batch mixture 445. Such combinations of starch and graphite can provide useful combinations of high average bulk porosity (% P) and relatively high median pore size (d₅₀) useful for filtration applications, while providing reduced cracking during initial firing ramp phase of firing the green honeycomb bodies 100G. In some embodiments, the starch pore former comprises a crosslinked starch.

The weight of the pore former (wpf) in the batch mixture 445 is computed as the wpf=wi×wt % SA/100, where wi is the total weight of inorganic raw materials batch mixture 445. The starch can have a median particle diameter (d₅₀) in the range from about 12 μm to 45 μm, or from about 20 μm to 35 μm in other embodiments. The graphite can have a median particle diameter (d₅₀) in the range from about 25 μm to 40 μm in some embodiments.

In some embodiments, the honeycomb-forming hatch mixture 445 comprises an organic binder. For example, the inorganic particulate batch components and/or pore former can first be blended with other dry processing aids, such as the organic binder. After dry blending, a liquid vehicle and other processing liquid aids, which can help impart a favorable rheology for extrusion and green strength to the raw materials, can be added. The organic binder can be a cellulose-containing material. For example, the cellulose-containing material can be, but is not limited to, methylcellulose, ethylhydroxy ethylcellulose, hydroxybutyl methylcellulose, hydroxymethylcellulose, hydroxypropyl methylcellulose, hydroxyethyl methylcellulose, hydroxybutylcellulose, hydroxyethylcellulose, hydroxypropylcellulose, sodium carboxy methylcellulose, and mixtures thereof. Methylcellulose and/or methylcellulose derivatives are especially suited as organic binders for use in the batch mixture 445, with methylcellulose and hydroxypropyl methylcellulose being suitable choices.

In some embodiments, combinations of cellulose-containing materials comprise mixtures of such materials with different molecular weights. Alternatively, the combination of cellulose-containing materials can comprise different hydrophobic groups or different concentrations of the same hydrophobic group. Different hydrophobic groups may be, by way of non-limiting example, hydroxyethyl or hydroxypropyl. The organic binder, in some embodiments, comprises a combination of a hydroxyethyl methylcellulose binder and a hydroxypropyl methylcellulose binder. Other suitable combinations of organic binders can be used.

The amount of organic binder provided in the batch mixture 445 can range from 3.0 wt % SAP to 8.0 wt % SAP, from 4.5 wt % SAP to 7.0 wt % SAP, or even from 4.5 wt % SAP to 6.0 wt % SAP, wherein wt % SAP is a superaddition based on 100% of the total weight of the inorganics plus pore formers that are present in the batch mixture 445.

The honeycomb body forming mixture can optionally further comprise other additives, for example rheology modifiers, dispersants, surfactants, or lubricants. Non-limiting examples of additives include fatty acids and tall oil.

Examples—Honeycomb Forming Batch Mixtures and Properties of Green and Ceramic Honeycomb Bodies

Tables 3A-3F illustrate several examples of the honeycomb-forming batch mixtures 445 comprising the aluminum titanate-containing particles 320 and properties of green honeycomb bodies 100G and ceramic honeycomb bodies 100 produced therefrom. The usage of “ND” throughout the Tables indicates that no data was collected for the corresponding entry.

TABLE 3A
Example embodiments of honeycomb-forming batch mixtures

| | Material | A1 | A2 | B1 | C1 |
|---|---|---|---|---|---|
| Inorganics | AT Particles (wt %) | 75.0 | 75.0 | 75.0 | 75.0 |
| | 16 μm Alumina (wt %) | 12.2 | 12.2 | 12.2 | 12.2 |
| | 28 μm Silica (wt %) | 6.3 | 6.3 | 6.3 | 6.3 |
| | 7 μm Talc (wt %) | 6.5 | 6.5 | 6.5 | 6.5 |
| Total | | 100.0 | 100.0 | 100.0 | 100.0 |
| Pore Former | Starch (wt % SA) | 3.0 | 3.0 | 3.0 | 3.0 |
| | Graphite (wt % SA) | 1.5 | 1.5 | 1.5 | 1.5 |
| Extrusion Aids | Methylcellulose (wt % SAP) | 6.0 | 6.0 | 6.0 | 6.0 |
| | Fatty Acid (wt % SAP) | 0.2 | 0.2 | 0.2 | 0.2 |
| Axial | Green Axial AT PIR | 0.43 | 0.47 | 0.47 | 0.49 |
| Orientation | (002)/(002 + 200) | | | | |
| | Fired Axial AT PIR | 0.51 | 0.52 | 0.43 | 0.46 |
| | (002)/(002 + 200) | | | | |

TABLE 3B
Example embodiments of honeycomb-forming batch mixtures

| | Material | D1 | F1 | G1 | H1 |
|---|---|---|---|---|---|
| Inorganics | AT Particles (wt %) | 75.0 | 75.0 | 75.0 | 75.0 |
| | 16 μm Alumina (wt %) | 12.2 | 12.2 | 12.2 | 12.2 |
| | 7 μm Talc (wt %) | 6.5 | 6.5 | 6.5 | 6.5 |
| | 28 μm Silica (wt %) | 6.3 | 6.3 | 6.3 | 6.3 |
| Total | | 100.0 | 100.0 | 100.0 | 100.0 |
| Pore Former | Starch (wt % SA) | 3.0 | 3.0 | 3.0 | 3.0 |
| | Graphite (wt % SA) | 1.5 | 1.5 | 1.5 | 1.5 |
| Extrusion Aids | Methylcellulose (wt % SAP) | 6.0 | 6.0 | 6.0 | 6.0 |
| | Fatty Acid (wt % SAP) | 0.2 | 0.2 | 0.2 | 0.2 |
| Axial | Green Axial AT PIR | 0.47 | 0.43 | 0.43 | 0.47 |
| Orientation | (002)/(002 + 200) | | | | |
| | Fired Axial AT PIR | 0.42 | 0.43 | 0.44 | ND |
| | (002)/(002 + 200) | | | | |

TABLE 3C
Example embodiments of honeycomb-forming batch mixtures 445

| | Material | C2 | E1a | E1b | F2a | F2b |
|---|---|---|---|---|---|---|
| Inorganics | AT Particles (wt %) | 75.0 | 75.0 | 75.0 | 75.0 | 75.0 |
| | 4 μm Alumina (wt %) | 11.9 | 12.2 | 12.2 | 11.9 | 11.9 |
| | 17 μm Talc (wt %) | — | 6.5 | 6.5 | — | — |
| | Magnesium Hydroxide (wt %) | 3.0 | — | — | 3.0 | 3.0 |
| | 28 μm Silica (wt %) | — | 6.3 | 6.3 | — | 10.1 |
| | 2.5 μm Silica (wt %) | 10.1 | — | — | 10.1 | — |
| Pore Former | Starch (wt % SA) | 6.0 | 20.0 | 22.0 | 10.0 | 10.0 |
| | Graphite (wt % SA) | — | 10.0 | 7.0 | — | — |
| Extrusion Aids | Methylcellulose (wt % SAP) | 6.0 | 6.0 | 6.0 | 6.0 | 6.0 |
| | Fatty Acid (wt % SAP) | 0.2 | 0.3 | 0.3 | 0.2 | 0.2 |
| AT Orientation | Fired Axial AT | 0.46 | ND | ND | ND | ND |
| | PIR(002)/(002 + 200) | | | | | |

TABLE 3D
Properties of example ceramic honeycomb bodies formed
using batch mixtures described in Table 3C.

| Firing Conditions of Temp (Time) | | C2 | E1a | E1b | F2a | F2b |
|---|---|---|---|---|---|---|
| 1344° C. (4 hrs) | Axial CTE | ND | ND | ND | ND | −0.4 |
| | (RT-800° C.), ×10⁻⁷/° C. | | | | | |
| | Tangential CTE | ND | ND | ND | ND | 3.8 |
| | (RT-800° C.), ×10⁻⁷/° C. | | | | | |
| | Porosity, % | ND | ND | ND | ND | 45.1 |
| | d₅₀ (μm) | ND | ND | ND | ND | 16.3 |
| 1355-1360° C. (4 hrs) | Axial CTE | 9.2 | 12.0 | 12.0 | 4.2 | 1.6 |
| | (RT-800° C.), 10e−7 | | | | | |
| | Tangential CTE | 14.9 | 21.8 | 21.3 | 9.5 | 6.9 |
| | (RT-800° C.), ×10⁻⁷/° C. | | | | | |
| | Porosity, % | 46.6 | 62.4 | 62.6 | 45 | 45.1 |
| | d₅₀ (μm) | 9.0 | 15.9 | 17.1 | 10.4 | 14.1 |
| 1365° C. (4 hrs) | Axial CTE | 7.0 | ND | ND | ND | 0.2 |
| | (RT-800° C.), ×10⁻⁷/° C. | | | | | |
| | Tangential CTE | 14.5 | ND | ND | ND | 7.3 |
| | (RT-800° C.), ×10⁻⁷/° C. | | | | | |
| | Porosity, % | 46.0 | ND | ND | ND | 45.1 |
| | d₅₀ (μm) | 9.3 | ND | ND | ND | 15.9 |
| 1371-1375° C. (4 hrs) | Axial CTE | 4.2 | 7.7 | 6.9 | ND | −1.7 |
| | (RT-800° C.), ×10⁻⁷/° C. | | | | | |
| | Tangential CTE | 10.8 | 17.1 | 15.7 | ND | 4.1 |
| | (RT-800° C.), ×10⁻⁷/° C. | | | | | |
| | Porosity, % | 45.6 | 61.1 | 60.7 | ND | 41.6 |
| | d₅₀ (μm) | 9.2 | 16.8 | 16.2 | ND | 17.8 |
| 1380° C. (2 hrs) | Axial CTE | 2.2 | ND | ND | ND | ND |
| | (RT-800° C.), ×10⁻⁷/° C. | | | | | |
| | Tangential CTE | 8.3 | ND | ND | ND | ND |
| | (RT-800° C.), ×10⁻⁷/° C. | | | | | |
| | Porosity, % | 43.9 | ND | ND | ND | ND |
| | d₅₀ (μm) | 10.4 | ND | ND | ND | ND |
| 1380° C. (4 hrs) | Axial CTE | 2.4 | ND | ND | ND | ND |
| | (RT-800° C.), ×10⁻⁷/° C. | | | | | |
| | Tangential CTE | 8.1 | ND | ND | ND | ND |
| | (RT-800° C.), ×10⁻⁷/° C. | | | | | |
| | Porosity, % | 45.0 | ND | ND | ND | ND |
| | d₅₀ (μm) | 9.7 | ND | ND | ND | ND |

TABLE 3E
Example embodiments of honeycomb-forming batch mixtures

| | Material | F2c | F2d | F2e | F2f | F2g |
|---|---|---|---|---|---|---|
| Inorganics | AT Particles (wt %) | 75.0 | 75.0 | 75.0 | 75.0 | 75.0 |
| | 4 μm Alumina (wt %) | 11.9 | 11.9 | 11.9 | 11.9 | 11.9 |
| | Magnesium Hydroxide | 3.0 | 3.0 | 3.0 | 3.0 | 3.0 |
| | (wt %) | | | | | |
| | 28 μm Silica (wt %) | — | 10.1 | — | 10.1 | 10.1 |
| | 2.5 μm Silica (wt %) | 10.1 | — | 10.1 | — | — |
| Pore Former | Starch (wt % SA) | 8.0 | 8.0 | — | — | 6.0 |
| | Graphite (wt % SA) | — | — | 12.0 | 12.0 | 6.0 |
| Extrusion Aids | Methylcellulose | 6.0 | 6.0 | 6.0 | 6.0 | 6.0 |
| | (wt % SAP) | | | | | |
| | Fatty Acid (wt % SAP) | 0.2 | 0.2 | 0.2 | 0.2 | 0.2 |

TABLE 3F
Properties of example ceramic honeycomb bodies formed
using batch mixtures described in Table 3C.

| Firing Conditions, Temp (Time) | | F2c | F2d | F2e | F2f | F2g |
|---|---|---|---|---|---|---|
| 1355-1360° C. (4 hrs) | Axial CTE | 9.0 | 2.1 | 11.0 | 2.2 | ND |
| | (RT-800° C.), ×10⁻⁷/° C. | | | | | |
| | Tangential CTE | 16.5 | 8.6 | 20.9 | 11.1 | ND |
| | (RT-800° C.), ×10⁻⁷/° C. | | | | | |
| | Porosity, % | 47.1 | 45 | 47.2 | 45.6 | ND |
| | d₅₀ (μm) | 9.3 | 15.1 | 9.2 | 14.6 | ND |
| 1365° C. (4 hrs) | Axial CTE | 5.3 | 0.3 | 6.2 | 1.2 | ND |
| | (RT-800° C.), ×10⁻⁷/° C. | | | | | |
| | Tangential CTE | 12.8 | 5.7 | 12.1 | 6.6 | ND |
| | (RT-800° C.), ×10⁻⁷/° C. | | | | | |
| | Porosity, % | 46.3 | 45.2 | 47 | 44.7 | ND |
| | d₅₀ (μm) | 9.9 | 16.7 | 8.8 | 15.6 | ND |
| 1371-1375° C. (4 hrs) | Axial CTE | 1.7 | −0.5 | 2.9 | −0.5 | −1.5 |
| | (RT-800° C.), ×10⁻⁷/° C. | | | | | |
| | Tangential CTE | 8.4 | 6.2 | 9.7 | 6.6 | 1.5 |
| | (RT-800° C.), ×10⁻⁷/° C. | | | | | |
| | Porosity, % | 46.3 | 44.2 | 46.5 | 44.6 | 41.3 |
| | d₅₀ (μm) | 9.6 | 16.4 | 8.7 | 15.8 | 18.6 |

In the various embodiments of Tables 3A-3F above, the honeycomb-forming batch mixture 445 is extruded into a green honeycomb body 100G (e.g., FIG. 5). The green honeycomb body 100G can be fired to form the ceramic honeycomb body 100. Thus, both the green honeycomb body 100G and the ceramic honeycomb body 100 comprise the plurality of intersecting walls 102 forming the channels 104, e.g., via extrusion through an extrusion die 444 as described herein. The walls (corresponding to walls 102) in the examples of Tables 3A-3F were from 8 μm to 12 μm in transverse thickness and the green honeycomb bodies had a cell density of about 275 cells per square inch (cpsi). Wall thickness from 2 μm to 15 μm and from 200-1000 cpsi are also possible.

As shown, the honeycomb-forming batch mixtures (batch mixture 445) in the examples of Tables 3A-3F comprise inorganics: made up of the aluminum titanate-containing particles (AT particles 320) comprising conglomerates of multiple partial grains mixed together with other inorganics such as at least an alumina source and a silica source. Some of the honeycomb-forming batch mixtures in Tables 3A-3F further comprise a magnesia source, such as talc, which is a hydrous magnesium silicate mineral with a chemical composition of Mg₃Si₄O₁₀(OH)₂. Thus, talc is both a magnesia source and a silica source.

In the depicted examples of Tables 3A-3F, the aluminum titanate-containing particles in the honeycomb-forming batch mixture 445 comprise 50 wt % or more, 60 wt % or more, or even 70 wt % or more, based on the total amount of inorganics in the batch mixture 445.

As described herein, the green honeycomb body (e.g., green honeycomb body 100G) is fired to forma ceramic honeycomb body (e.g., ceramic honeycomb body 100). Various firing conditions of top soak temperature and time (hours) are shown in the Tables 3D and 3F. In accordance with the examples, ceramic honeycomb bodies 100 produced using the batch mixtures 445 can have average bulk porosities (% P) greater than 40%, greater than 45%, greater than 50%, greater than 55%, or greater than 60%, such as from 40% to 65%, from 45% to 65%, from 50% to 65%, from 55% to 65%, or from 60% to 65%, for example. D₅₀ can range from 9.0 μm to 20 μm, for example. Furthermore, ceramic honeycomb bodies 100 produced using the batch mixtures 445 can have a coefficient of axial thermal expansion (“Axial CTE”) of less than 10.0×10⁻⁷/° C. from room temperature (RT) to 800° C., for example. In embodiments, such as those fired at 1365° C. for example, the coefficient of axial thermal expansion (“Axial CTE”) can be less than or equal to 6.0×10⁻⁷/° C. from RT to 800° C. In some embodiments, such as those fired at 1380° C. for example, the coefficient of axial thermal expansion (“Axial CTE”) can be less than or equal to 3.0×10⁻⁷/° C. from RT to 800° C.

In some embodiments, the coefficient of tangential thermal expansion (“Tangential CTE”) can be less than or equal to 16.5×10⁻⁷/° C. from RT to 800° C. In certain embodiments, the coefficient of tangential thermal expansion (“Tangential CTE”) can be less than or equal to 14.5×10⁻⁷/° C. from RT to 800° C., less than or equal to 10×10⁻⁷/° C. from RT to 800° C., or even less than or equal to 5.0×10⁻⁷/° C. from RT to 800° C., and can be less than or equal to 2.0×10⁻⁷/° C. from RT to 800° C. in some embodiments.

FIG. 6 illustrates the peak intensity ratio (PIR) in the axial orientation for green honeycomb bodies made from honeycomb-forming batches comprising different aluminum titanate-containing particles, which different aluminum titanate-containing particles were made using various different sintering aids. As shown, the green honeycomb bodies made from honeycomb-forming batch mixtures that comprised aluminum titanate particles that were formed from first batch mixtures that comprised 1 wt % cordierite or 1 wt % of a combination of clay and talc had relatively lower PIR values in the axial orientation of the AT than the other green honeycomb bodies. All wt % values of the sintering aid are based on a total weight of inorganics in the corresponding batch mixture or body.

The peak intensity ratio (PIR) of (002)/(002+200) is lower for the green ware with the aluminum-titanate particles comprising cordierite or talc/clay combination than for the comparative materials including either no sintering aid or 3% colloidal silica in the AT-containing particles. This relatively-lower PIR in the pseudobrookite phase indicates higher randomization of the orientation of the AT grains. In some embodiments, the peak intensity ratio (PIR) in the pseudobrookite phase is PIR≤0.50, PIR≤0.49, PIR≤0.48, PIR≤0.47, PIR≤0.46, PIR≤0.45, PIR≤0.44, PIR≤0.43, or even PIR≤0.42, or any range including these values as endpoints, e.g., from 0.42 to 0.50, from 0.42 to 0.49, from 0.42 to 0.48, from 0.42 to 0.47, from 0.42 to 0.46, from 0.42 to 0.45, from 0.43 to 0.49, from 0.44 to 0.49, or from 0.42 to 0.48. In contrast, green honeycomb bodies made from AT particles that comprised 3 wt % silica, 1 wt % mullite, 1 wt % CaSiO₃, or no sintering aid in their batch mixtures, all had PIR values greater than 0.5, i.e., from about greater than 0.5 to about 0.75, although those with silica, mullite, or CaSiO₃ were concentrated toward the lower end of this range (e.g., up to about 0.65 in the case of silica, at about 0.55 in the case of mullite, and between 0.5 and 0.55 in the case of CaSiO₃).

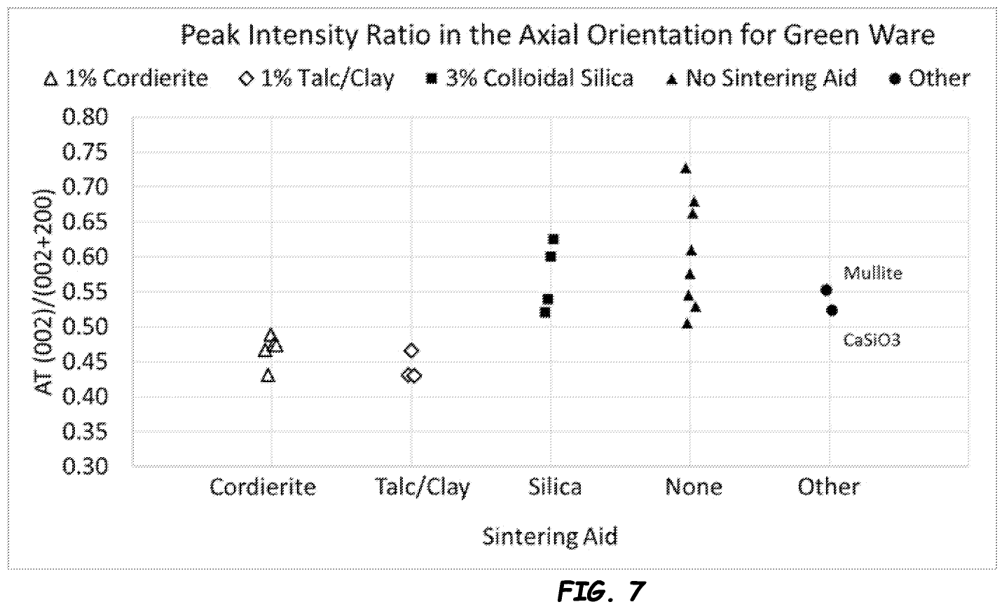

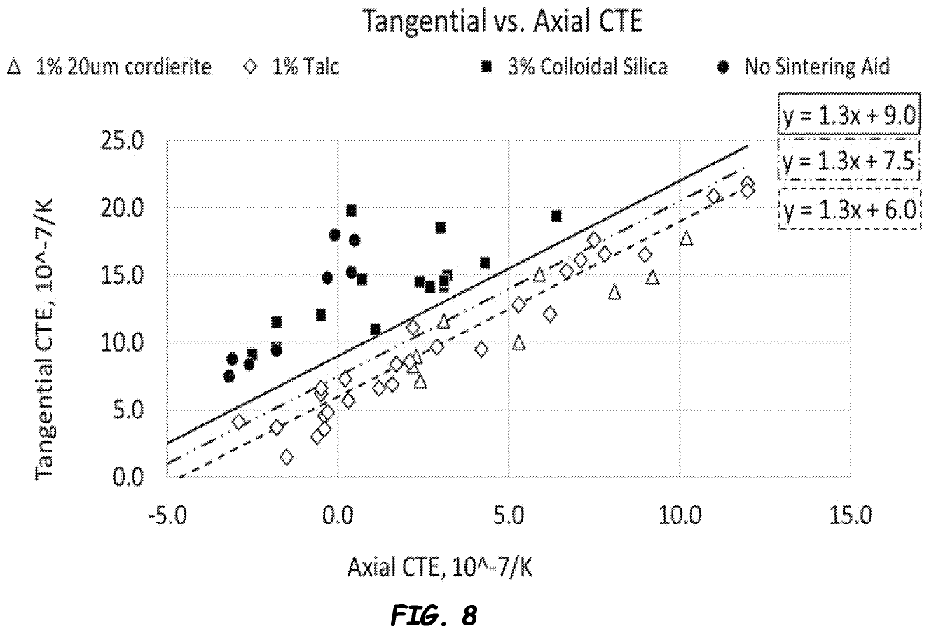

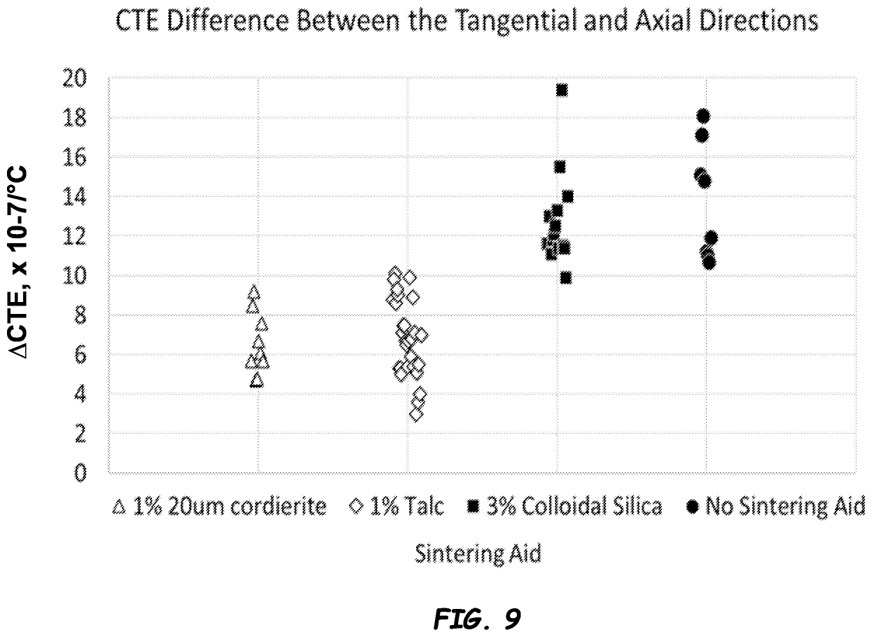

FIG. 7 illustrates a plot showing the coefficient of tangential thermal expansion (Tangential CTE) with respect to the coefficient of axial thermal expansion (Axial CTE) for various ceramic honeycomb bodies comprising different AT particles, which AT particles were made from different sintering aids. The values of CTE are measured from room temperature (RT) to 800° C. Linear plots of the Tangential CTE and Axial CTE data illustrate that ceramic honeycomb bodies comprising AT particles that were made using cordierite or talc as a sintering aid, even in low amounts of 1 wt % or less can exhibit relatively lower anisotropy than honeycomb bodies made from AT particles that did not comprise these materials as a sintering aid.

The solid line in FIG. 7 characterized by the mathematical relationship: y=3x+9.0×10⁻⁷/° C. illustrates a line of demarcation between ceramic honeycomb bodies made from AT particles that had no sintering aid or 3 wt % silica as the sintering aid (e.g., corresponding to the green bodies in FIG. 6 having PIR values greater than 0.5) and those comprising AT particles that were made using talc or cordierite as a sintering aid (e.g., corresponding to the green bodies in FIG. 6 having PIR values less than 0.5). Examples falling on or below the line y=3x+9.0×10⁻⁷/° C. exhibit improved tangential to axial ratios and have less anisotropy in the AT-containing phase. In some embodiments, the tangential CTE as a function of the axial CTE has a value that falls below the line defined by y=3x+k, where k is ≤9.0×10⁻⁷/° C. In some embodiments, the tangential to axial CTE ratio falls on or below the line y=1.3x+7.5×10⁻⁷/° C., while in further embodiments, the tangential to axial CTE ratio falls on or below the line y=1.3x+6.0×10⁻⁷/° C. In each case y is tangential CTE and x is axial CTE of the walls of the ceramic honeycomb body (e.g., the walls 102 of the ceramic honeycomb body 100).

FIG. 8 illustrates a plot showing a difference (or delta) between the tangential CTE and axial CTE for various ceramic honeycomb bodies comprising different AT particles, which AT particles were made from different sintering aids. In some embodiments, the CTE difference (ΔCTE) of tangential CTE minus axial CTE is ΔCTE≤9.0×10⁻⁷/° C. from RT to 800° C. In some embodiments, the CTE difference (ΔCTE) of tangential CTE minus axial CTE is ΔCTE≤8.0×10⁻⁷/° C. from RT to 800° C., ΔCTE≤7.0×10⁻⁷/° C. from RT to 800° C., ΔCTE≤6.0×10⁻⁷/° C. from RT to 800° C., ΔCTE≤5.0×10⁻⁷/° C. from RT to 800° C., ΔCTE≤4.0×10⁻⁷/° C. from RT to 800° C., or even ΔCTE≤3.0×10⁻⁷/° C. from RT to 800° C., including ranges defined by any of these values as endpoints, such as ΔCTE (measured from RT to 800° C.) from 3.0×10⁻⁷/° C. to 9.0×10⁻⁷/° C., from 3.0×10⁻⁷/° C. to 8.0×10⁻⁷/° C., from 3.0×10^{71° C. to} 7.0×10⁻⁷/° C., from 3.0×10^{71° C. to} 6.0×10⁻⁷/° C., from 3.0×10⁻⁷/° C. to 5.0×10⁻⁷/° C., or from 3.0×10⁻⁷/° C. to 4.0×10⁻⁷/° C. Embodiments exhibiting ΔCTE≤8.0×10⁻⁷/° C. from RT to 800° C. illustrate substantially improved isotropy.

It is to be understood that both the foregoing general description and the detailed description provided by the examples provided herein are explanatory and are not intended to be restrictive. The accompanying figures, which are incorporated in and constitute a part of this specification, are not intended to be restrictive, but rather illustrate various embodiments of the disclosure. Other embodiments will be apparent to those skilled in the art from consideration of the specification and practice of the disclosure.

It will be apparent to those skilled in the art that various modifications and variations can be made to the present disclosure without departing from the scope thereof. Thus, it is intended that the present disclosure covers the modifications and variations of this disclosure provided they come within the scope of the claims and their equivalents.

1. A method of manufacturing aluminum titanate-containing particles, comprising:
forming a batch mixture of inorganic materials from:
an alumina source,
a titania source,
a sintering aid comprising at least one of clay, talc, or cordierite, wherein the sintering aid is provided in the batch in an amount of from at least 0.1 wt % to less than or equal to 5 wt % based upon the total weight of inorganics in the batch mixture;
forming a green body from the batch mixture;
firing the green body to form a ceramic body comprising grains of aluminum titanate,
forming intragranular microcracks in the grains of aluminum titanate; and
breaking the ceramic body along the microcracks to form the aluminum titanate-containing particles.

2. The method of claim 1, wherein forming the intragranular microcracks comprises cooling the ceramic body.

3. The method of claim 1, wherein the aluminum titanate-containing particles comprise a conglomerate of multiple partial grains of aluminum titanate bonded together by one or more silica-containing bonding layers at grain boundaries between the partial grains, wherein the multiple partial grains in each aluminum titanate-containing particle have multiple different grain orientations.

4. The method of claim 1, wherein after firing the ceramic body has less than 1 wt % of a crystalline cordierite phase.

5. (canceled)

6. (canceled)

7. The method of claim 1, wherein the aluminum titanate-containing particles comprise one or more of:
a median particle diameter of from 18 μm to 70 μm;
a particle distribution having d_{f}≤1.0; and
d₁₀≥5 _{μm.}

8. (canceled)

9. The method of claim 1, comprising removing one or more particle fractions from the aluminum titanate-containing particles to form sieved aluminum titanate-containing particles comprising a median particle diameter of from 25 μm to 55 μm.

10. The method of claim 1, wherein the batch mixture further comprises Mg(OH)₂, or magnesium aluminate (spinel).

11. (canceled)

12. (canceled)

13. (canceled)

14. The method of claim 1, wherein one or more of:
the source of titania comprises rutile phase titania or anatase phase titania; and
the source of alumina comprises hydrated alumina, calcined alumina, or magnesium aluminate (spinel).

15. (canceled)

16. (canceled)

17. (canceled)

18. (canceled)

19. The method of claim 1, wherein the batch mixture contains less than or equal to 1.8 wt % of silica based upon the total weight of inorganics in the batch mixture.

20. The method of claim 1, wherein the sintering aid comprises at least one of:
clay having a median particle diameter of less than 40 μm;
talc having a median particle diameter from 5 μm to 40 μm; and
cordierite having a median particle diameter of less than 50 μm.

21. (canceled)

22. The method of claim 20, wherein the batch mixture comprises at least one of:
the talc in an amount of less than or equal to 2.8 wt % based upon the total weight of inorganics in the batch mixture; and
the cordierite in an amount of less than or equal to 3.5 wt % based upon the total weight of inorganics in the batch mixture.

23. (canceled)

24. (canceled)

25. (canceled)

26. The method of claim 1, wherein the firing the green body comprises is carried out at a top soak temperature of from 1350° C. to 1700° C. for a firing time from 1 hour to 10 hours.

27. (canceled)

28. (canceled)

29. (canceled)

30. The method of claim 1, wherein the forming a green body from the batch mixture comprises extruding strands or granularizing.

31. (canceled)

32. The method of claim 1, wherein the aluminum titanate-containing particles comprise at least one of:
partial grains, each partial grain further having faces created by by intragrain fractures; and
a conglomerate of multiple partial grains, the conglomerate of multiple partial grains comprising substantially no microcracking therein.

33. (canceled)

34. (canceled)

35. The method of claim 32, wherein the ceramic body comprises substantially no intergranular microcracks before breaking.

36. An aluminum titanate-containing particle, comprising:
a conglomerate of multiple partial grains of aluminum titanate bonded together by one or more silica-containing bonding layers at grain boundaries between the partial grains, wherein the multiple partial grains have multiple different grain orientations.

37. The aluminum titanate particle of claim 36, comprising one or more of:
substantially no internal microcracking; and
substantially-pure solid solution of aluminum titanate and magnesium dititanate.

38. (canceled)

39. The aluminum titanate particle of claim 37, comprising:
less than 25 wt % of the magnesium dititanate; or
greater than or equal to 98 wt % of a solid solution of aluminum titanate and magnesium dititanate.

40. (canceled)

41. (canceled)

42. (canceled)

43. (canceled)

44. (canceled)

45. (canceled)

46. (canceled)

47. (canceled)

48. (canceled)

49. A ceramic honeycomb body, comprising:
an aluminum titanate-containing phase comprising axial CTE and tangential CTE falling on or below the line y=1.3x+9.0×10⁻⁷ wherein y is tangential CTE and x is axial CTE each measured from RT to 800° C. and in units of 10⁻⁷/° C. wherein the aluminum titanate-containing phase comprises particles made up of a conglomerate of multiple partial grains.

50. (canceled)

51. (canceled)

52. The ceramic honeycomb body of claim 49, wherein the multiple partial grains comprise intragranularly fractured surfaces.

53. The green honeycomb body of claim 49, wherein the multiple partial grains are bonded by one or more silica-containing bonding layers to form the conglomerate.

54. (canceled)

55. (canceled)

56. (canceled)

57. (canceled)
